(19) United States
(12) Patent Application Publication
(10) Pub. No.: US 2005/0065805 A1
(43) Pub. Date: Mar. 24, 2005

(54) Tool and method for operations, management, capacity, and services business solution for a telecommunications network

(76) Inventor: Omayma El-Sayed Moharram, Carleton Place (CA)

Correspondence Address: OMCS Consultants Inc., RR1 STN MAIN, 225 Spruce Crescent, Carleton Place, ON, K7C 3P1, CA

(21) Appl. No.: 10/668,133

(22) Filed: Sep. 24, 2003

(51) Int. Cl. G06F 17/60

(52) U.S. Cl. 705/1; 705/10

(57) ABSTRACT

An operations, management, capacity, and services (OMCS) tool and method are presented for analyzing business parameters for a plurality of network architectures; and comparing the business parameters for said network architectures for determining cost savings of one network architecture versus another and for determining a business solution that articulates the network architecture for reducing total expenditure. The business parameters comprise capital expenditure (CAPEX), operational expenditure (OPEX), total expenditure, revenue, capacity, return on investment (ROI), and other business and financial statistics. The OMCS tool and method determine the business solution for an owned, a leased, or partially owned and leased telecommunications network. The business solution further comprises network architecture having network elements (NEs), customer premise equipment (CPE), and links from the same or different equipment suppliers; and having network, service, and customer management processes from the same or different management processes suppliers.

### FIELD OF THE INVENTION

This invention relates generally to business tools and, in particular, to tool and method for operations, management, capacity, and services (OMCS) business solution for a telecommunications network.

### BACKGROUND OF THE INVENTION

Increases in Internet use, web hosting services, electronic-business relationships, and multimedia applications are driving service providers to deploy new technology in local, metro, and wide area networks to meet customers' demands for more bandwidth with specified granularity. These services in today's networks (such as time division multiplexing (TDM), asynchronous transfer mode (ATM), and frame relay (FR)) can be difficult and costly to operate and manage.

Particularly, new technology alternatives for network architectures are creating critical challenges for the service providers' operations, management, capacity, and services. These technology alternatives comprise Internet protocol (IP), virtual private network (VPN), multi protocol label switching (MPLS), and optical Ethernet (OE), to name just a few. The inter-working and inter-operability between the different technologies create issues within the service provider's network and increase its operating cost.

To keep up with the introduction of the new technology, service providers need tools to compare capital and operating costs of each technology alternatives for their network architectures. Service providers also need tools to quantify the impact of the technology alternatives on their business and revenue.

Additionally, management processes for the new technology are challenging, could be costly, and could limit the service providers' timely delivery of new services to their end users. These management processes comprise network, service, and customer management processes. To reduce management processes cost and enable service providers to select the appropriate technology for their network architectures, the operational expenditure (OPEX) for the management processes must be evaluated for each technology alternatives for the network architectures.

Prior arts offer tools for developing business solution for service provider's network, wherein the operational expenditure (OPEX) for the management processes is estimated as a percentage of expected revenue and combined with capital expenditure (CAPEX). Technology alternatives for network architectures are not considered in the business solution and service providers cannot appreciate the difference between one architecture technology and another. Further, by considering the OPEX as a percentage of revenue, the service providers would not be able to identify the management processes areas for enhancing or reducing their operating cost.

Consequently, there is a need in the industry to provide improved methods and tools for developing business solutions comprising comprehensive analysis of capital and operational expenditures for technology alternatives for network architectures.

### SUMMARY OF THE INVENTION

It is an object of the present invention to provide an operations, management, capacity, and services (OMCS) tool and method for developing business solutions for a telecommunications network.

The invention, therefore, according to one aspect provides an operations, management, capacity, and services (OMCS) tool comprises a means for analyzing business parameters for a plurality of network architectures; and comparing the business parameters for said network architectures for determining cost savings of one network architecture versus another and for determining a business solution that articulates the network architecture for reducing total expenditure.

The business parameters comprise the total expenditure; and wherein the total expenditure comprises capital expenditure (CAPEX) and operational expenditure (OPEX). The CAPEX comprises a network architecture cost; taxes; interests; and deprecation and amortization (D/A) expenses. The OPEX comprises a management processes cost; a leasing cost; and sales, general and administration (SG&A) expenses.

The business parameters further comprise revenue; capacity; return on investment (ROI); earnings before interest, taxes, and deprecation and amortization (EBITDA); earnings before interest and taxes (EBIT); OPEX as percentage of revenue; and total expenditure as percentage of revenue.

The OMCS tool means for analyzing the business parameters comprises means for analyzing the business parameters for a network architecture having one or more of the following technology: TDM, ATM, FR, IP, VPN, MPLS, and optical Ethernet including fiber, synchronous optical network (SONET), resilience packet ring (RPR), and dense wavelength division multiplexing (DWDM). This means further comprises a means for computing the business parameters for each of said network architectures over a pre-determined study period.

The OMCS tool means for comparing the business parameters for the plurality of network architectures comprises means for reporting the business parameters for each of said network architectures over said pre-determined study period, wherein the business solution comprises the network architecture with the least total expenditure.

The OMCS tool further comprises means for engineering a plurality of network architectures for a pre-determined input user data; determining a network architecture cost and a leasing cost for each of said network architectures over a pre-determined study period; engineering management processes for managing each of said network architectures; and determining a management processes cost for said management processes over said pre-determined study period. The tool further comprises means for inputting user data; and validating and calibrating the input user data; the network architecture cost; the leasing cost; and the management processes cost for each of said network architectures.

The OMCS tool means for engineering the plurality of network architectures comprises a means for determining an owned network elements (NEs) count; a leased NEs count; an owned customer premise equipment (CPE) count; a leased CPE count; an owned links count; a leased links count; and a leased ports count for each of said network architectures; and wherein said network architectures having NEs, CPE, and links from the same or different equipment suppliers.

The OMCS tool means for determining the network architecture cost and the leasing cost for each of the plurality of network architectures comprises means for determining an owned cost (a price) per network element (NE), a footprint per NE cost, and a power consumption per NE cost; determining an owned cost (a price) per CPE, a footprint per CPE cost, and a power consumption per CPE cost; and determining an owned cost (a price) per link and a link transmission rate.

The means for determining the network architecture cost comprises means for computing a total owned NEs cost; a total owned CPE cost; and a total owned links cost for each of said network architectures over said pre-determined study period. The means for determining the leasing cost comprises a means for computing a total footprints cost and a total power consumptions cost for said NEs and CPE over said pre-determined study period.

The OMCS tool means for determining the leasing cost further comprises means for determining a leased per NE cost, a footprint per NE cost, and a power consumption per NE cost; determining a leased per CPE cost, a footprint per CPE cost, and a power consumption per CPE cost; determining a leased per link cost and a link transmission rate; determining a leased link per unit length cost, a unit length per link count, and a link transmission rate; and determining a leased per port cost. This means further comprises means for computing a total leased NEs cost; a total leased CPE cost; a total footprints cost and a total power consumptions cost for said NEs and CPE; a total leased links cost; a total leased links for unit length cost; and a total leased ports cost for each of said network architectures over said pre-determined study period.

The OMCS tool means for engineering the management processes comprises means for engineering network management processes; and service and customer management processes, wherein said management processes having said processes from the same or different management processes suppliers.

The means for engineering network management processes comprises a means for selecting one or more of the following processes: inside plant maintenance; outside plant maintenance; network engineering; network provisioning; installation; testing; and repairs.

The means for engineering service and customer management processes comprises a means for selecting one or more of the following processes: customer relationship management (CRM); work order management (WOM); network inventory management (NAI); service activation and provisioning (SAP); fault management (FM); performance management (PM); accounting and billing; and security management.

The OMCS tool means for determining the management processes cost comprises a means for determining a process cost per NE for each of said network management processes for one or more of the following: a manual operations mode; a mechanized operations mode; and a manual and mechanized operations mode. The means for determining the management processes cost further comprises a means for determining a process cost per link for each of said service and customer management processes for one or more of the following: a manual operations mode; a mechanized operations mode; and a manual and mechanized operations mode.

Another aspect of the invention provides a computer program containing instructions for directing a computer to perform a process for analyzing business parameters for a plurality of network architectures, and comparing the business parameters for said network architectures over a pre-determined study period.

The program comprises means for causing the computer to receive data for the plurality of network architectures; analyze the received data to compute the business parameters for said network architectures; and compare said computed business parameters for said network architectures for determining cost savings of one network architecture versus another and for determining a business solution that articulates the network architecture for reducing total expenditure.

The program means for causing the computer to receive the data for the plurality of network architectures comprises means for causing the computer to receive input user data; network architectures data; and management processes data for said network architectures. The input user data comprises traffic data; customer data; and financial and labour data for the plurality of network architectures. The network architectures data comprises network elements (NEs) data; CPE data; links and ports data; and further comprises network architectures options for said network architectures. The management processes data comprises network management data; service and customer management data; and further comprises network management options; and service and customer management options for managing each of said network architectures.

The program means for causing the computer to analyze the received data comprises a means for causing the computer to compute the business parameters for said network architectures over said pre-determined study period.

The program means for causing the computer to compare said business parameters for said network architectures comprises a means for causing the computer to tabulate and graphically chart the business parameters for said network architectures over said predetermined study period.

In accordance with a first embodiment of this invention, the program is a self-contained Microsoft EXCEL-based decision support software tool comprises a plurality of EXCEL workbooks. A number of EXCEL workbooks are for receiving input user data; network architectures data and options; and management processes data and options. A workbook is for analyzing and combining the received data; and another workbook for computing the business parameters for a plurality of network architectures. In yet another workbook, the computed business parameters are tabulated and graphically charted for each of said network architectures.

In accordance with a second embodiment of this invention, the program is a self-contained software tool comprises a plurality of sub-programs linked together and the sub-programs are written in one or more of the following computer languages: machine language, C/C++, virtual basic, and Java. A number of sub-programs are for receiving input user data; network architectures data and options; and management processes data and options. A sub-program is for analyzing and combining the received data; and another sub-program is for computing the business parameters for a plurality of network architectures. The computed business parameters are then passed to another sub-program for tabulating and graphically charting the business parameters for each of said network architectures.

A further aspect of the invention provides a method for developing business solution for a telecommunications network using the OMCS tool. The method comprises the steps of receiving data for a plurality of network architectures; analyzing the received data to compute business parameters for said network architectures; and comparing said computed business parameters for said network architectures for determining cost savings of one network architecture versus another and for determining a business solution that articulates the network architecture for reducing total expenditure.

The business parameters comprise the total expenditure; and wherein the total expenditure comprises CAPEX and OPEX. The business parameters further comprise business and financial statistics comprising revenue, capacity, ROI, EBITDA, EBIT, OPEX as percentage of revenue, and total expenditure as percentage of revenue.

The step of receiving data comprises a step of receiving input user data; network architectures data; management processes data; network architectures options; network management processes options; and service and customer management processes options for the plurality of network architectures.

The step of analyzing the business parameters comprises a step of analyzing the business parameters for a network architecture having one or more of the following technology: TDM, ATM, FR, IP, VPN, MPLS, and optical Ethernet including fiber, SONET, RPR, and DWDM. This step further comprises a step of adjusting and updating data for said network architectures.

The step of comparing the business parameters for the plurality of network architectures comprises a step of reporting said business parameters for said network architectures over a predetermined study period; and wherein the business solution comprises the network architecture with the least total expenditure and said network architecture having NEs, CPE, and links from the same or different equipment suppliers; and having network, service, and customer management processes from the same or different management processes suppliers.

The step of reporting the business parameters further comprises a step of tabulating and graphically charting the business parameters for each of said network architectures over said pre-determined study period.

This invention provides an operations, management, capacity, and services (OMCS) tool and method for developing business solution for a telecommunications network. The OMCS tool automates the calculation of the business parameters for a plurality of network architectures and enables comparison of technology alternatives for said network architectures. The OMCS tool provides a comprehensive business solution that articulates the savings of one network architecture versus another and identifies the areas for cost reduction.

The embodiments of the present invention provide improved software tools and methods for business solution for a telecommunications network that would overcome the shortcomings and limitations of the prior arts.

### BRIEF DESCRIPTION OF THE DRAWINGS

The invention will be better understood from the following description of a preferred embodiment together with reference to the accompanying drawing, in which:

FIG. 1 is a diagram illustrating an operations, management, capacity, and services (OMCS) tool in accordance with an embodiment of the present invention;

FIG. 2 is a diagram illustrating an OMCS tool's architecture for the OMCS tool of FIG. 1;

FIG. 3 is a diagram illustrating a fully meshed architecture for a telecommunications network;

FIG. 4 is a diagram illustrating a non-meshed architecture for a telecommunications network;

FIG. 5 is a table illustrating network elements (NEs) data for the OMCS tool architecture of FIG. 2;

FIG. 6 is a table illustrating customer premise equipment (CPE) data for the OMCS tool architecture of FIG. 2;

FIG. 7 is a table illustrating links and ports data for the OMCS tool architecture of FIG. 2;

FIG. 8 is a table illustrating customer relationship management (CRM) data for the OMCS tool architecture of FIG. 2;

FIG. 9 is a table illustrating work order management (WOM) data for the OMCS tool architecture of FIG. 2;

FIG. 10 is a table illustrating network inventory management (NIM) data for the OMCS tool architecture of FIG. 2;

FIG. 11 is a table illustrating service activation and provisioning (SAP) data for the OMCS tool architecture of FIG. 2;

FIG. 12 is a table illustrating fault management (FM) data for the OMCS tool architecture of FIG. 2;

FIG. 13 is a table illustrating performance management (PM) data for the OMCS tool architecture of FIG. 2;

FIG. 14 shows tables illustrating network management data; network architectures options; and service and customer management options for the OMCS tool architecture of FIG. 2;

FIG. 15 shows tables illustrating network management options; traffic data; and customer data for the OMCS tool architecture of FIG. 2;

FIG. 16 is a table illustrating financial and labour data for the OMCS tool architecture of FIG. 2;

FIG. 17 is a flow diagram illustrating a method for developing business solution for a telecommunications network using the OMCS tool of FIG. 1;

FIG. 18 shows a graph of exemplary result from the OMCS tool of FIG. 1;

FIG. 19 shows a graph of another exemplary result from the OMCS tool of FIG. 1;

FIG. 20 shows a graph of another exemplary result from the OMCS tool of FIG. 1; and

FIG. 21 shows a graph of yet another exemplary result from the OMCS tool of FIG. 1.

### DESCRIPTION OF THE PREFERRED EMBODIMENTS

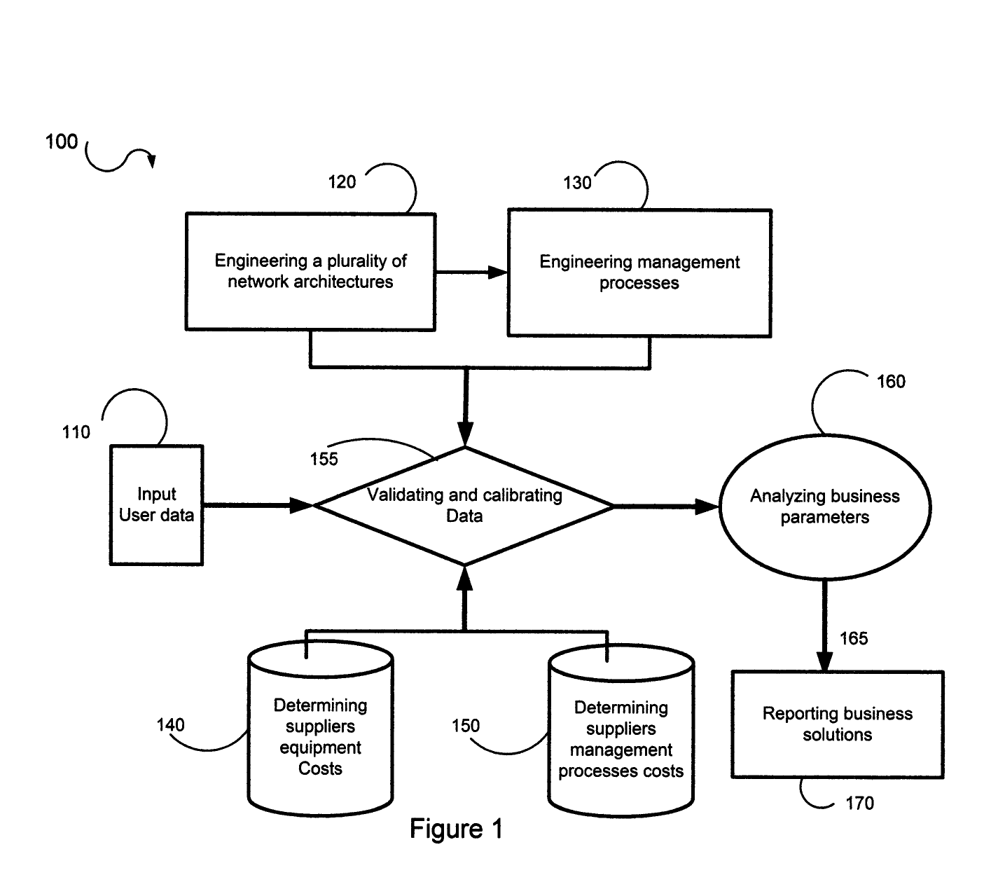

FIG. 1 shows a diagram illustrating an operations, management, capacity, and services (OMCS) tool 100 comprising software modules for input user data 110; engineering a plurality of network architectures 120; determining suppliers equipment costs 140; engineering management processes 130; determining suppliers management processes costs 150; validating and calibrating data 155; analyzing business parameters 160; and reporting business solutions 170.

The input user data 110 module enables an analyst to input user data and options for a plurality of network architectures to be modeled. The input user data comprises traffic data; customer data; and financial and labour data. The options enable the analyst to select technology alternatives for network architectures and management processes for managing said network architectures.

The options for the technology alternatives for network architectures comprise one or more of the following: time division multiplexing (TDM), asynchronous transfer mode (ATM), frame relay (FR), Internet protocol (IP), virtual private network (VPN), multi protocol label switching (MPLS), and optical Ethernet including fiber, synchronous optical network (SONET), resilience packet ring (RPR), and dense wavelength division multiplexing (DWDM). The options for the management processes enable the analyst to select the network management processes, and service and customer management processes for managing said technology alternatives for the network architectures.

The network architectures to be modeled are configured in the engineering a plurality of network architectures 120 module and network architectures data for said network architectures are determined. A network architecture cost and a leasing cost for each of said network architectures are determined by communicating with the determining suppliers equipment costs 140 module. This module communicates with suppliers' equipment database (not shown) for costing (owned and leased) network elements (NEs), customer premise equipment (CPE), and links for each of the network architectures.

The engineering management processes 130 module defines management processes for managing each of said network architectures and the determining supplier management processes costs 150 module determines their costs. The determining supplier management processes costs 150 module communicates with a suppliers' management processes database (not shown) for costing each management process for network, service, and customer management.

The validating and calibrating data 155 module validates and calibrates the data received from the input user data 110 module; the engineering a plurality of network architectures 120 module; the engineering management processes 130 module; the determining suppliers equipment costs 140 module; and the determining suppliers management processes costs 150 module, to ensure that service, customer, and network requirements and management are met in terms of quality of service (QoS) and network capacity.

The analyzing business parameters 160 module combines the data received from the validating and calibrating data 155 module to compute business parameters for each of said network architectures over a pre-determined study period, wherein the pre-determined study period comprises a plurality of a pre-determined time periods, (for example, for a pre-determined time period of one year, the pre-determined study period could be five or ten years).

The business parameters comprise total expenditure, wherein the total expenditure comprises capital expenditure (CAPEX) and operational expenditure (OPEX). The CAPEX comprises a network architecture cost, taxes, interests, and deprecation and amortization (D/A) expenses; and the OPEX comprises a management processes cost; a leasing cost; and sales, general and administration (SG&A) expenses.

The business parameters further comprise financial and business statistics comprising revenue; capacity; return on investment (ROI); earnings before interest, taxes, and deprecation and amortization (EBrIDA); earnings before interest and taxes (EBIT); OPEX as percentage of revenue; and total expenditure as percentage of revenue.

The reporting business solutions 170 module reports in tables and graphical charts the business parameters for each of said network architectures over said pre-determined study period.

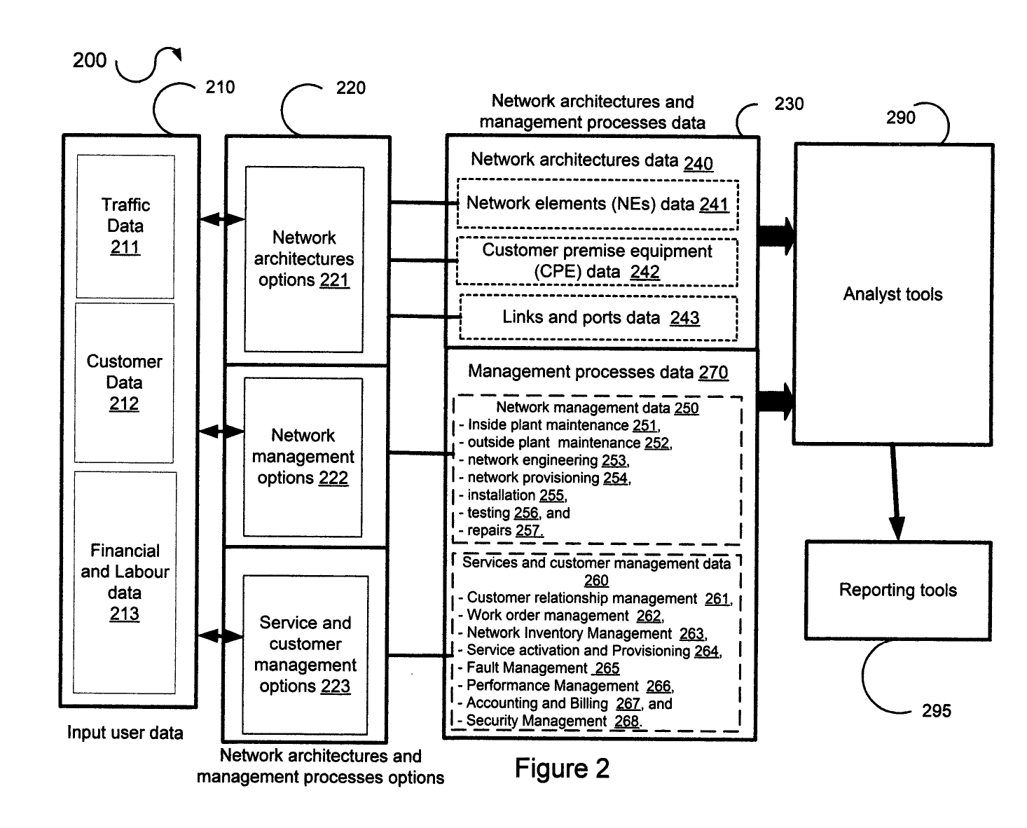

FIG. 2 shows a diagram 200 illustrating an OMCS tool architecture for the OMCS tool of FIG. 1. The OMCS tool architecture 200 comprises input user data 210; network architectures and management processes options 220; network architectures and management processes data 230; analyst tools 290, and reporting tools 295.

The input user data 210 stores data received from an analyst for engineering and costing a plurality of network architectures. The received data comprises traffic data 211; customer data 212; and financial and labour data 213.

The network architectures and management processes options 220 stores the analyst network architectures options 221; network management options 222; and service and customer management options 223 for said plurality of network architectures. The network architectures and management processes data 230 stores network architectures data 240 and management processes data 270 for managing said network architectures.

The network architectures data 240 comprises network elements (NEs) data 241; customer premise equipment (CPE) data 242; and links and ports data 243. The management processes data 270 comprises network management data 250 and service and customer management data 260.

The network management data 250 comprises data for inside plant maintenance 251, outside plant maintenance 252, network engineering 253, network provisioning 254, installation 255, testing 256, and repairs 257.

The service and customer management data 260 comprises data for customer relationship management (CRM) 261, work order management (WOM) 262, network inventory management (NIM) 263, service activation and provisioning (SAP) 264, fault management (FM) 265, performance management (PM) 266, accounting and billing 267, and security management 268.

The analyst tools 290 combine the data received from the input user data 210; network architectures and management options 220; and network architectures and management processes data 230, to compute the business parameters for each of the network architectures over the pre-determined study period. The analyst tools 290 comprise well known computing and arithmetic operations and general accounting functions.

The reporting tools 295 tabulate and graphically chart said business parameters for said network architectures over said pre-determined study period. The reporting tools 295 comprise well known tables and graphical charts capabilities.

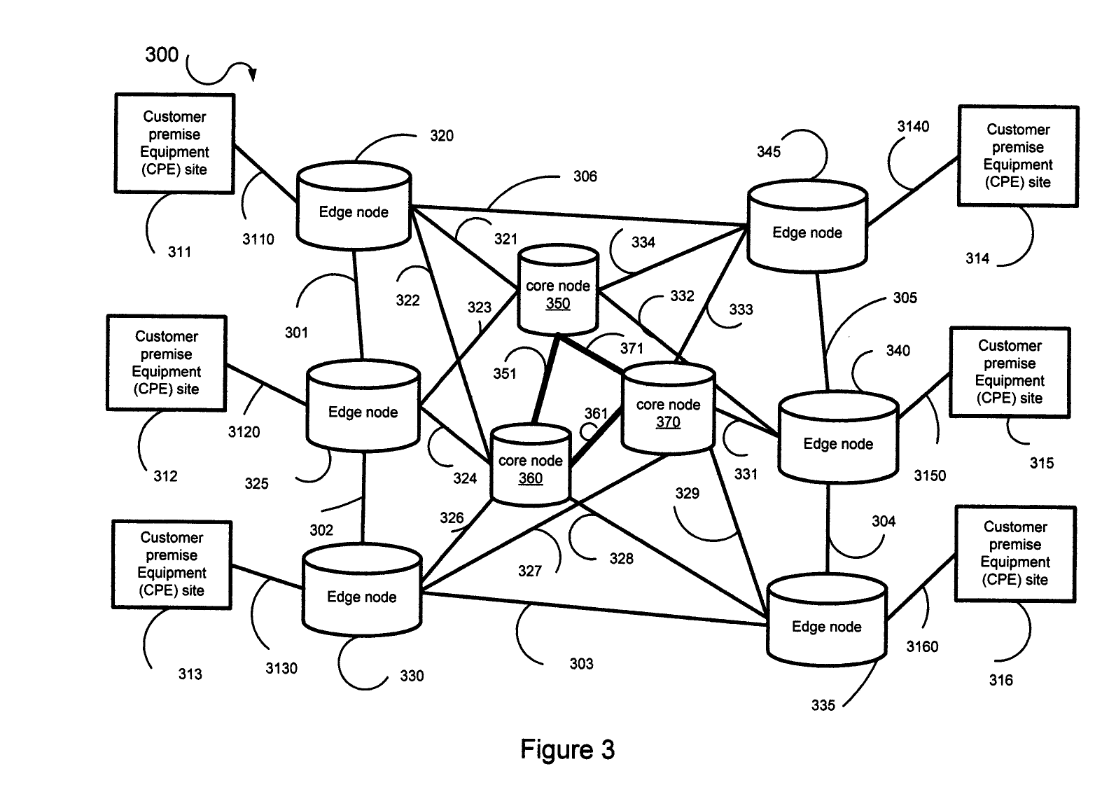

FIG. 3 shows a diagram illustrating a fully meshed architecture for a telecommunications network 300 comprising a plurality of customer premise equipment (CPE) sites 311 to 316, wherein each CPE site having a number of equipment including Ethernet switches, routers, terminals (not shown). The CPE sites 311 to 316 are connected to a plurality of edge nodes 320, 325, 330, 335, 340, and 345, respectively, via a plurality of links 3110, 3120, 3130, 3140, 3150, and 3160. The plurality of edge nodes 320, 325, 330, 335, 340, and 345 are connected to a plurality of core nodes 350, 360, and 370 via a plurality of links 321, 322, 323, 324, 326, 327, 328, 329, 331, 332, 333, and 334. The plurality of edge nodes 320, 325, 330, 335, 340, and 345 are inter-connected via links 301to 306, respectively. The plurality of core nodes 350, 360, and 370 are inter-connected via links 351, 361, and 371. Equipment such as add/drop multiplexers and cross-connect nodes (not shown) may be located on the links between the edge nodes 320, 325, 330, 335, 340, and 345; the core nodes 350, 360, and 370; and the CPE sites 311 to 316 for meeting the services and network requirements.

Network architectures options 221 of FIG. 2 for the network of FIG. 3 would include one or more of the following technology: TDM, AIM, and FR, for example; and determining network architectures data 240 of FIG. 2 for the network of FIG. 3 comprises determining network elements (NEs) data 241; CPE data 242; and links and ports data 243 of FIG. 2 over a pre-determined study period. The network elements (NEs) data 241 comprises data for edge nodes, core nodes, and other equipment such as add/drop multiplexers and cross connect nodes.

The management processes for managing the network of FIG. 3 are determined by selecting the processes in the network management options 222, and service and customer management options 223 of FIG. 2; and determining the management processes data 270 comprises determining the network management data 250 and the service and customer management data 260 of FIG. 2 over said pre-determined study period.

Analyzing and reporting the business parameters for the network of FIG. 3 comprise analyzing and reporting said business parameters for said network architectures over said pre-determined study period.

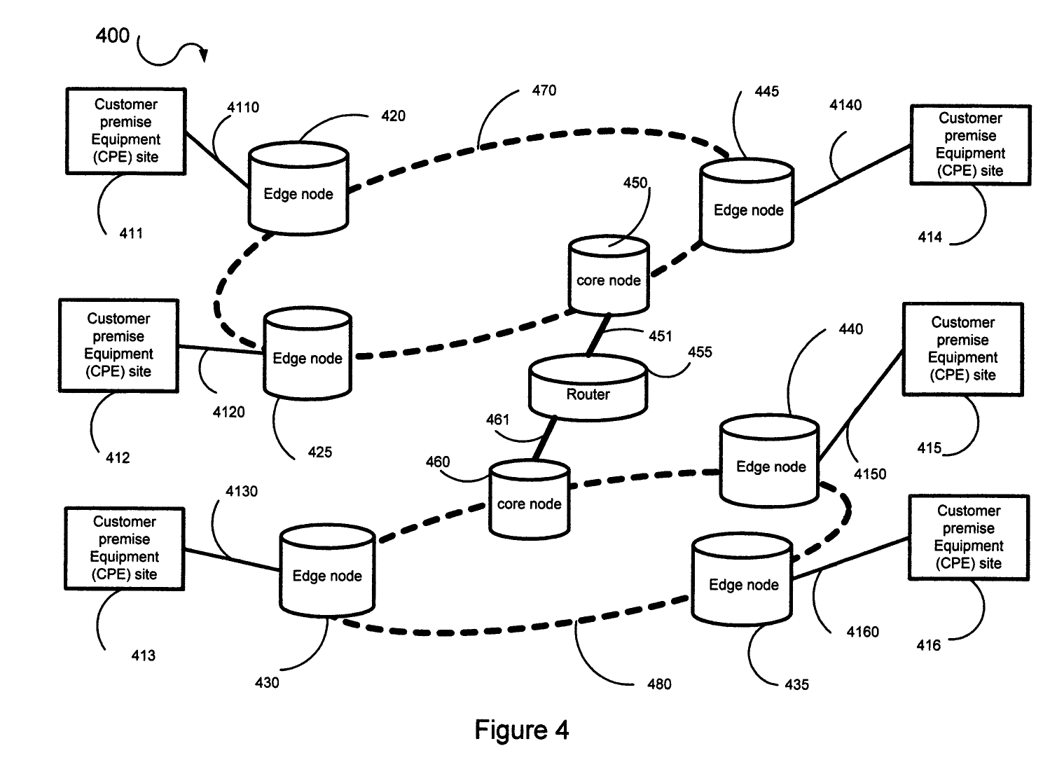

FIG. 4 shows a diagram illustrating a non-meshed architecture for a telecommunications network 400 comprising a plurality of customer premise equipment (CPE) sites 411 to 416, wherein each CPE site having a number of equipment including Ethernet switches, routers, terminals (not shown). The CPE sites 411 to 416 are connected to a plurality of edge nodes 420, 425, 430, 435, 440, and 445, respectively, via a plurality of links 4110, 4120, 4130, 4140, 4150, and 4160. The network architecture of FIG. 4 comprises a ring network 470 for communications of edge nodes 420, 425, and 445, and core node 450; and another ring network 480 for communications of edge nodes 430, 435, and 440, and core node 460. The core node 450 on the ring 470 and the core node 460 on the other ring 480 communicate via link 451, router 455, and another link 461. Equipment such as add/drop multiplexers and cross-connect nodes (not shown) may be located on the links between the edge nodes 420, 425, 430, 435, 440, and 445; the core nodes 450 and 460; and the CPE sites 411 to 416 for meeting the services and network requirements.

Network architectures options 221 of FIG. 2 for the network of FIG. 4 would include one or more of the following technology: IP, VPN, MPLS, and optical Ethernet including fiber, SONET, RPR, and DWDM, for example; and determining network architectures data 240 of FIG. 2 for the network of FIG. 4 comprises determining network elements (NEs) data 241; CPE data 242; and links and ports data 243 of FIG. 2 over a pre-determined study period. The network elements (NEs) data 241 comprises data for edge nodes, core nodes, and other equipment such as add/drop multiplexers and cross connect nodes.

The management processes for managing the network of FIG. 4 are determined by selecting the processes in the network management options 222, and service and customer management options 223 of FIG. 2; and determining the management processes data 270 comprises determining the network management data 250 and service and customer management data 260, of FIG. 2 over said pre-determined study period.

Analyzing and reporting the business parameters for the network of FIG. 4 comprise analyzing and reporting said business parameters for said network architectures over said pre-determined study period.

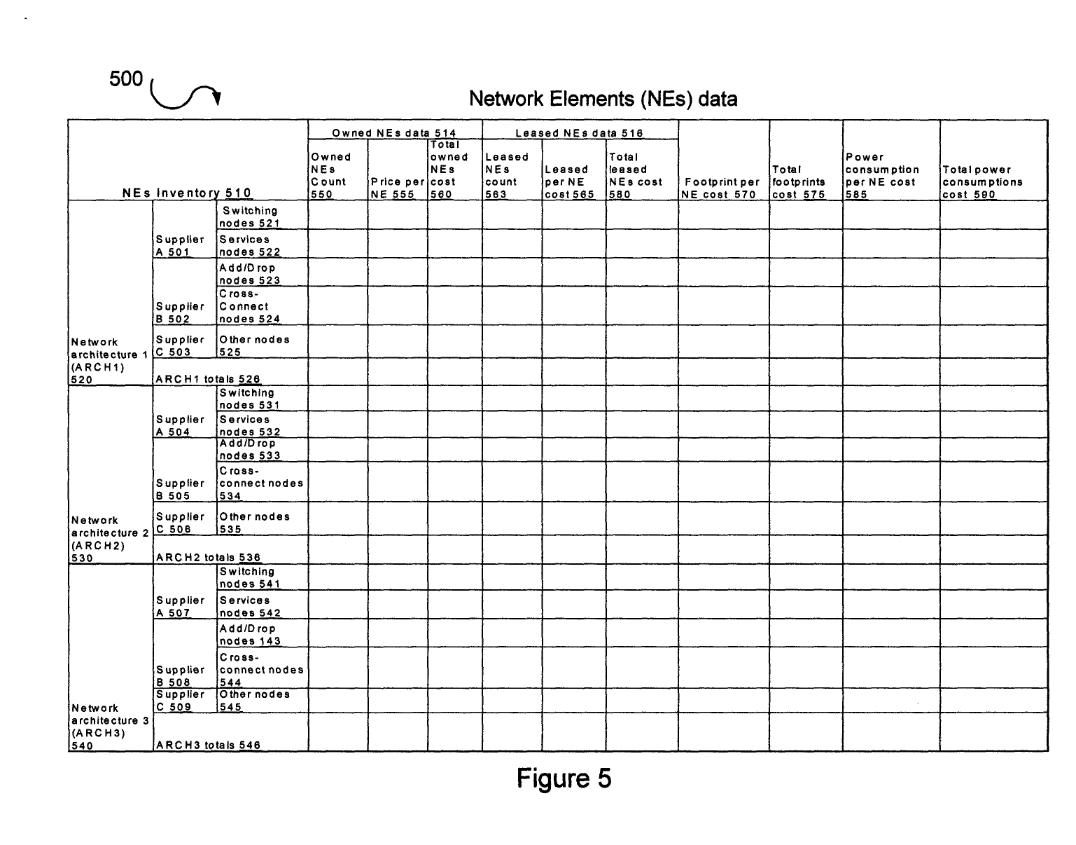

FIG. 5 shows a table 500 illustrating a network elements (NEs) data, wherein three network architectures ARCH1 520, ARCH2 530, and ARCH3 540 are shown. The network architectures comprise NEs from the same or different equipment suppliers.

The ARCH1 520 having switching nodes 521 and services nodes 522 from supplier A 501; add/drop nodes 524 and cross-connect nodes 524 from supplier B 502; and other nodes 525 from supplier C 503. The ARCH2 530 having switching nodes 531 and services nodes 532 from supplier A 504; add/drop nodes 534 and cross-connect nodes 534 from supplier B 505; and other nodes 535 from supplier C 506. The ARCH3 540 having switching nodes 541 and services nodes 542 from supplier A 507; add/drop nodes 544 and cross-connect nodes 544 from supplier B 508; and other nodes 545 from supplier C 509.

In table 500, a network elements (NEs) inventory 510 comprises an owned NEs data 514 having an owned NEs count 550, a price per network element (NE) 555, and a total owned NEs cost 560; a leased NEs data 516 having a leased NEs count 563, a leased per NE cost 565, and a total leased NEs cost 580; a footprint (space) per NE cost 570 and a total footprints cost 575; and a power consumption per NE cost 585 and a total power consumptions cost 590. All costs are determined using one currency over a pre-determined time period, for example, in dollars per year.

A total footprints cost 575 is determined by multiplying the sum of the owned NEs counts 550 and the leased NEs count 563 by the footprint per NE cost 570. A total owned NEs cost 560 is determined by multiplying the owned NEs count 550 by the price per NE 555. A total leased NEs cost 580 is determined by multiplying the leased NEs counts 563 by the leased per NE cost 565. A total power consumptions cost 590 is determined by multiplying the sum of the owned NEs count 550 and the leased NEs count 563 by the power consumption per NE cost 585.

The ARCH1 totals 526 are determined by summing up the total owned NEs cost 560, the total leased NEs cost 580, the total footprints cost 575, and the total power consumptions cost 590 for the suppliers A 501, B 502, and C 503. The ARCH2 totals 536 are determined by summing up the total owned NEs cost 560, the total leased NEs cost 580, the total footprints cost 575, and the total power consumptions cost 590 for the suppliers A 504, B 505, and C 506. The ARCH3 totals 546 are determined by summing up the total owned NEs cost 560, the total leased NEs cost 580, the total footprints cost 575, and the total power consumptions cost 590 for the suppliers A 507, B 508, and C 509.

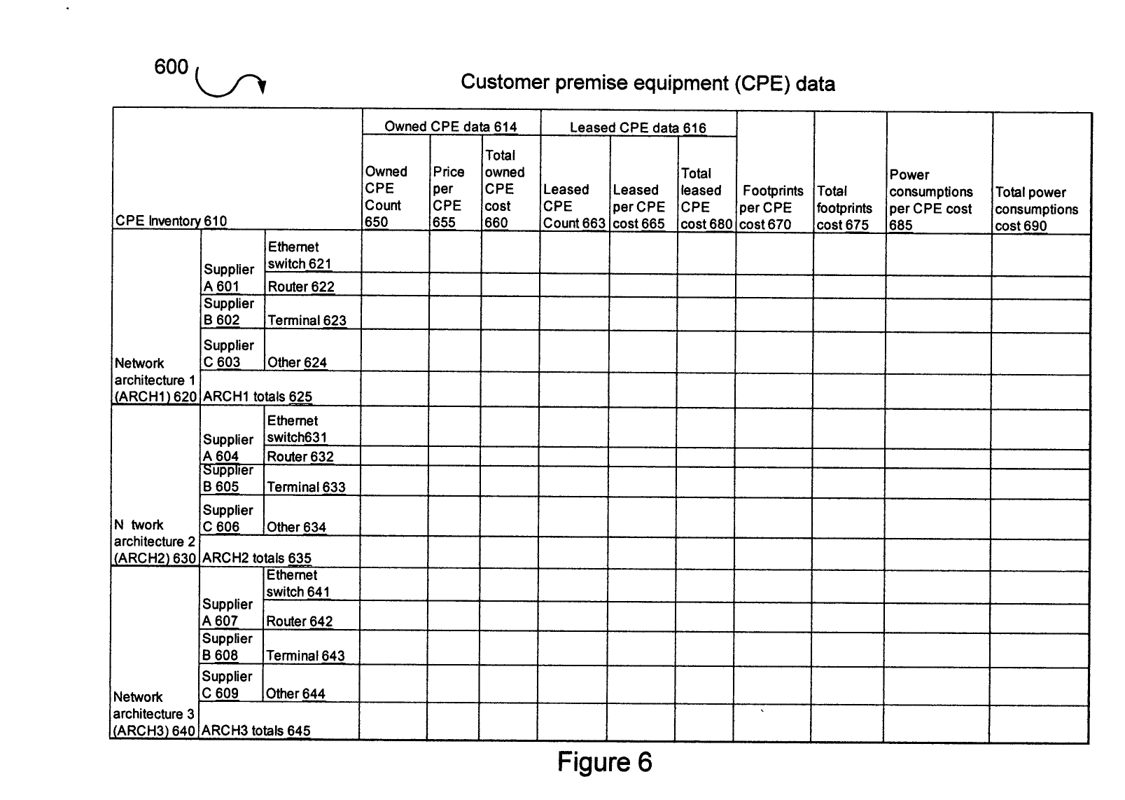

FIG. 6 shows a table 600 illustrating customer premise equipment (CPE) data, wherein three network architectures ARCH1 620, ARCH2 630, and ARCH3 640 are shown. The network architectures comprise CPE from the same or different equipment suppliers.

The ARCH1 620 having Ethernet switching equipment 621 and routing equipment 622 from supplier A 601; terminal equipment 623 from supplier B 602; and other equipment 624 from supplier C 603. The ARCH2 630 having Ethernet switching equipment 631 and routing equipment 632 form supplier A 604; terminal equipment 633 from supplier B 605; and other equipment 634 from supplier C 606. The ARCH3 640 having Ethernet switching equipment 641 and routing equipment 642 from supplier A 607; terminal equipment 643 from supplier B 608; and other equipment 644 from supplier C 609.

In table 600, a CPE inventory 610 comprises an owned CPE data 614 having an owned CPE count 650, a price per CPE 655, and a total owned CPE cost 660; a leased CPE data 616 having a leased CPE count 663, a leased per CPE cost 665, and a total leased CPE cost 680; a footprint per CPE cost 670 and a total footprints cost 675; and a power consumption per CPE cost 685 and a total power consumptions cost 690. All costs are determined using one currency over a pre-determined time period, for example, in dollars per year.

A total footprints cost 675 is determined by multiplying the sum of the owned CPE count 650 and the leased CPE count by the footprint per CPE cost 670. A total owned CPE cost 660 is determined by multiplying the owned CPE count 650 by the price per CPE 655. A total leased CPE cost 680 is determined by multiplying the leased CPE count 663 by the leased per CPE cost 665. A total power consumptions cost 690 is determined by multiplying the sum of the owned CPE count 650 and the leased CPE count 663 by the power consumption per CPE cost 685.

The ARCH1 totals 625 are determined by summing up the total owned CPE cost 660, the total leased CPE cost 680, the total footprints cost 675, and the total power consumptions cost 690 for the suppliers A 601, B 602, and C 603. The ARCH2 totals 635 are determined by summing up the total owned CPE cost 660, the total leased CPE cost 680, the total footprints cost 675, and the total power consumptions cost 690 for the suppliers A 604, B 605, and C 606. The ARCH3 totals 645 are determined by summing up the total owned CPE cost 660, the total leased CPE cost 680, the total footprints cost 675, and the total power consumptions cost 690 for the suppliers A 607, B 608, and C 609.

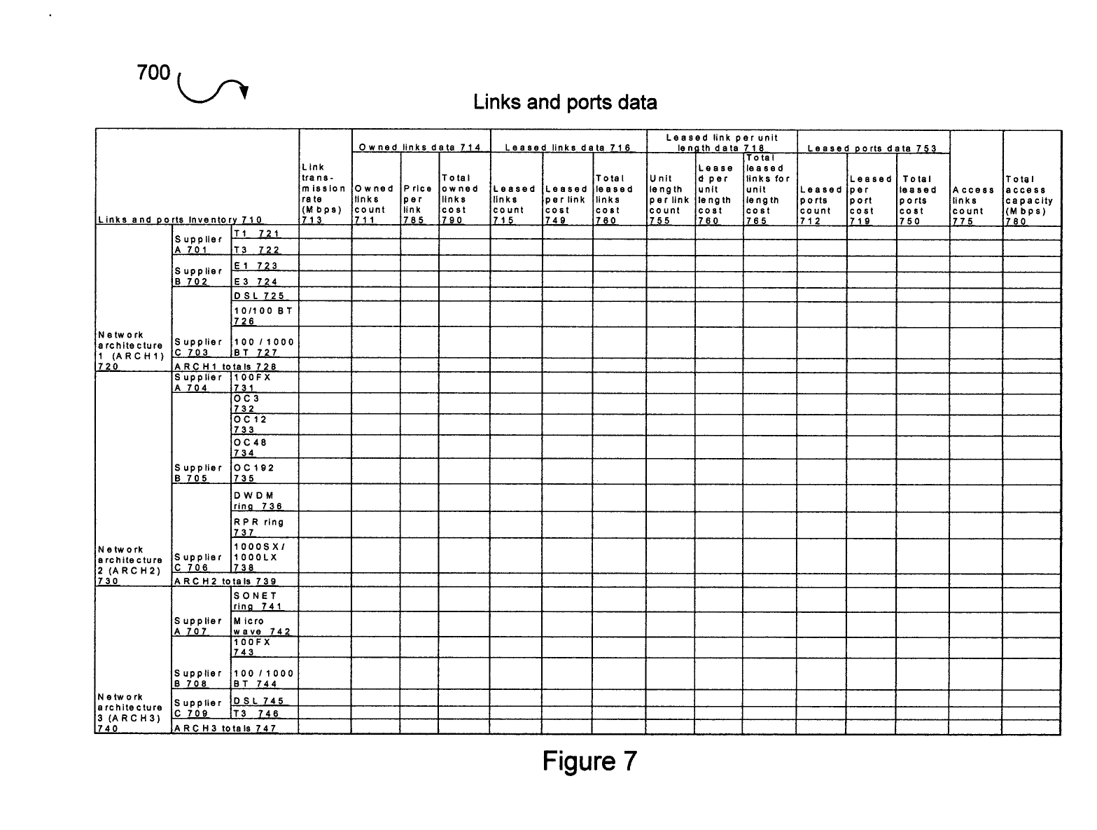

FIG. 7 shows a table 700 illustrating links and ports data, wherein three network architectures ARCH1 720, ARCH2 730, and ARCH3 740 are shown. The network architectures comprise links and rings from the same or different equipment suppliers.

The ARCH1 720 having T1 721 and T3 722 links from supplier A 701; E1 723 and E3 724 links from supplier B 702; and DSL links 725, 10/100 BT 726, and 100/1000 BT 727 links from supplier C 703. The ARCH2 730 having fiber 100FX 731 from supplier A 704; OC3 732, OC12 733, OC48 734, and OC 192 links from supplier B 705; and DWDM ring 736, RPR ring 737, and 1000SX/1000LX 738 from supplier C 706. The ARCH3 740 having SONET ring 741 and microwave 742 links from supplier A 707; fiber 100 FX 743 and 100/1000 BT 744 links from supplier B 708; and DSL 745 and T3 746 links from supplier C 709.

In table 700, a links and ports inventory 710 comprises a link transmission rate 713 (in Mbps, for example); an owned links data 714 having an owned links count 711, a price per link 785, and a total owned links cost 790; a leased links data 716 having a leased links count 715, a leased per link cost 749, and a total leased links cost 760; a leased link per unit length data 718 having a unit length per link count 755, a leased per unit length cost 760, and a total leased links for unit length cost 765; a leased ports data 753 having a leased ports count 712, a leased per port cost 719, and a total leased ports cost 750; and an access links count 775 and a total access capacity 780, (in Mbps, for example). All costs are determined using one currency over a pre-determined time period, for example, in dollars per year.

A total owned links cost 790 is determined by multiplying the owned links count 711 by the price per link 785. A total leased links cost 760 is determined by multiplying the leased links count 715 by the leased per link cost 749. A total leased links for unit length cost 765 is determined by multiplying the leased links count 715 by the unit length per link count 755 and by the unit length per link cost 760. A total leased ports cost 750 is determined by multiplying the leased ports count 712 by the leased per port cost 719. The access capacity 780 is determined by multiplying the access links count 775 by the link transmission rate 713.

The ARCH1 totals 728 are determined by summing up the total owned links cost 790, the total leased links cost 760, the total leased links for unit length cost 765, and the total leased ports cost 750 for the suppliers A 701, B 702, and C 703. The ARCH2 totals 739 are determined by summing up the total owned links cost 790, the total leased links cost 760, the total leased links for unit length cost 765, and the total leased ports cost 750 for the suppliers A 704, B 705, and C 706. The ARCH3 totals 747 are determined by summing up the total owned links cost 790, the total leased links cost 760, the total leased links for unit length cost 765, and the total leased ports cost 750 for the suppliers A 707, B 708, and C 709.

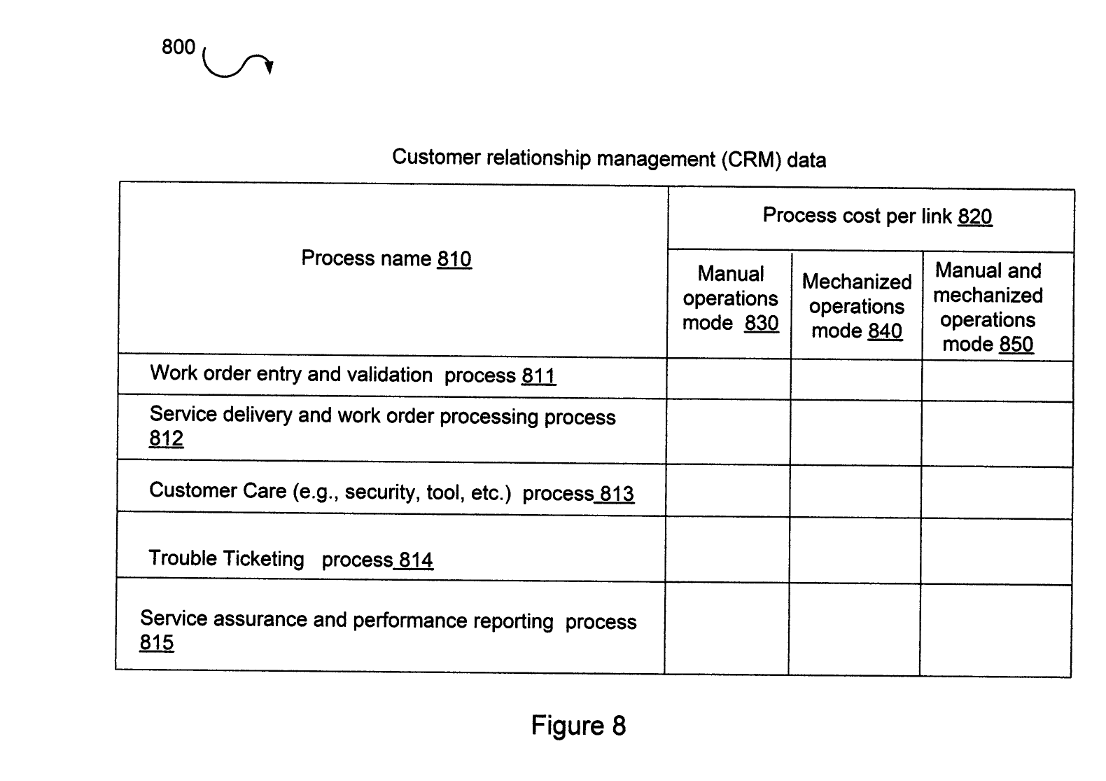

FIG. 8 shows a table 800 illustrating customer relationship management (CRM) data comprising a process name 810 and a process cost per link 820. The process cost per link 820 is determined for a manual operations mode 830, a mechanized operation mode 840, and a manual and mechanized operations mode 850 for each CRM process. All costs are determined using one currency over a pre-determined time period, for example, in dollars per year.

Under the process name 810, the CRM processes are listed, wherein the CRM processes comprise a work order entry and validation process 811; a service delivery and work order processing process 812; a customer care process 813; a trouble ticketing process 814; and a service assurance and performance reporting process 815.

The work order entry and validation process 811 comprises tasks for an order capture; an order validation; a work order decomposition; an order processing; and an order post processing. The service delivery and work order processing process 812 comprises tasks for searching and displaying of all orders; filtering customer services reports (CSR) on service types and/or service status; storing historical information on the service and/or customer; capturing order and generating quotation; and displaying product catalogue.

The customer care process 813 comprises tasks for security, tools, and creating and verifying trouble tickets. The trouble ticketing process 814 comprises tasks for service level definitions including generating a service level template for a service package; adding availability and quality of service (QoS); defining threshold for a potential service level agreement (SLA) violation; mapping a pre-defined template to a particular service; and customizing template on any variance for customer.

The service assurance and performance reporting process 815 comprises tasks for service level agreement (SLA) including collecting performance data from selected devices; collecting errors seconds (ES) and severely errors seconds (SES) to drive QoS metric; collecting unavailability seconds (UAS) to track service availability; assessing QoS and availability metrics; generating reports on daily, weekly, monthly, and quarterly bases; processing order metrics; processing problem resolution metrics; and distributing reports via the web portal or other means.

Since some of the CRM processes 811 to 815 could be performed manually and other using mechanized tools (e.g., operations support systems (OSSs)), the total CRM processes cost is computed by multiplying the owned links count 711 in Table 700 of FIG. 7 for each network architecture by the process cost per link 820 for manual and mechanized operations mode 850 for the CRM processes 811 to 815. For fully mechanized operations, the process cost per link 820 for the manual operations mode 830 and the manual and mechanized operations mode 850 would be zero for the CRM processes 811 to 815. And for only manual operations, the process cost per link 820 for the mechanized operations mode 840 and for the manual and mechanized operations mode 850 would be zero for the CRM processes 811 to 815.

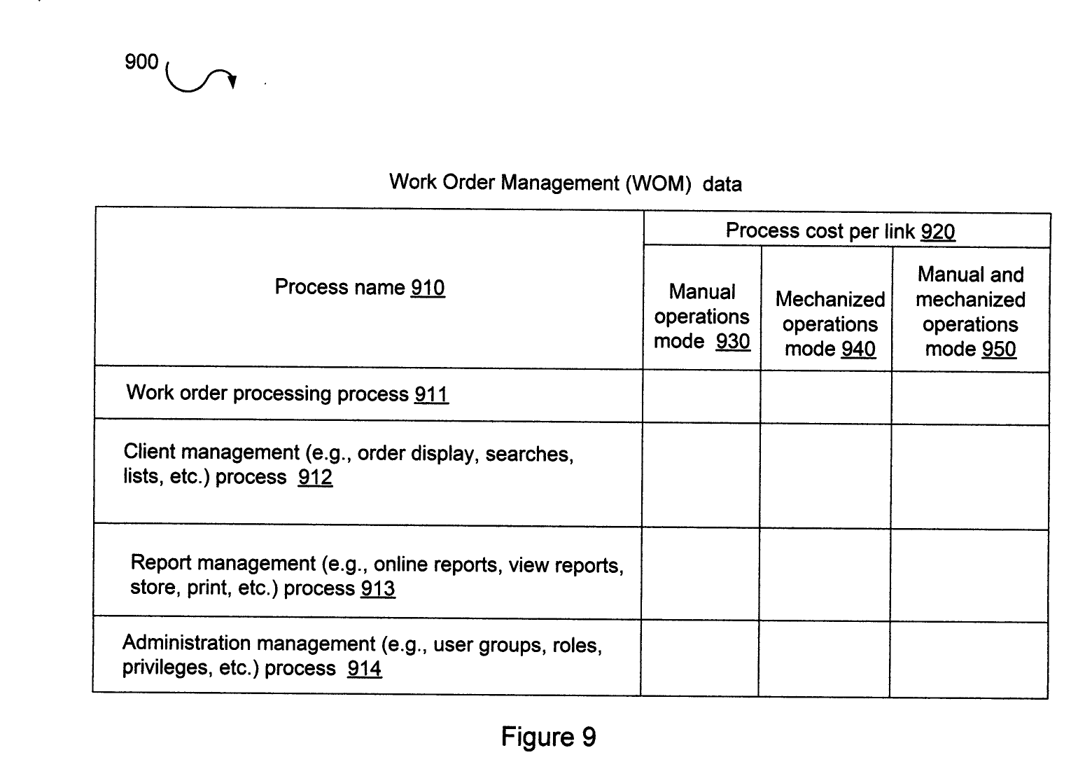

FIG. 9 shows a table 900 illustrating work order management (WOM) data comprising a process name 910 and a process cost per link 920. The process cost per link 920 is determined for a manual operations mode 930, a mechanized operation mode 940, and a manual and mechanized operations mode 950 for each WOM process. All costs are determined using one currency over a pre-determined time period, for example, in dollars per year.

Under the process name 910, the WOM processes are listed, wherein the WOM processes comprise a work order processing process 911; a client management process 912; a report management process 913; and an administration management process 914.

The work order processing process 911 comprises tasks for receiving order request; processing order; identifying order status; and notifying order status. The client management process 912 comprises tasks for order listing; order displaying; order auditing; and order searching. The report management process 913 comprises tasks for online reporting; pending orders viewing; order volume viewing; and order performance viewing. The administration management process 914 comprises tasks for setting up new users; setting up workgroups; assigning roles and privileges; defining order template; defining tasks and processes; and defining security measures.

For combined manual and mechanized operations, the total WOM processes cost is computed by multiplying the owned links count 711 in Table 700 of FIG. 7 for each network architecture by the process cost per link 920 for the manual and mechanized operations mode 950 for the WOM processes 911 to 914. For fully mechanized operations, the process cost per link 920 for the manual operations mode 930 and for the manual and mechanized operations mode 950 would be zero for the WOM processes 911 to 914. And for only manual operations, the process cost per link 920 for the mechanized operations mode 940 and the manual and mechanized operations mode 950 would be zero for the WOM processes 911 to 914.

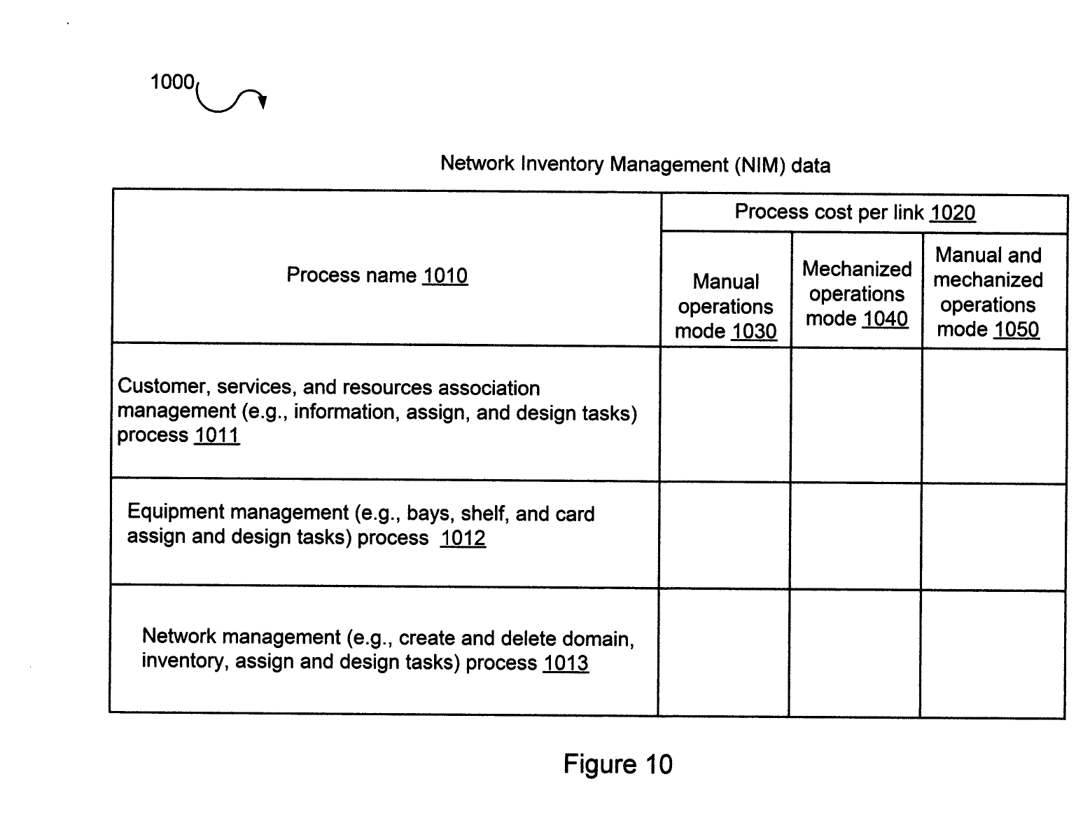

FIG. 10 shows a table 1000 illustrating network inventory management (NIM) data comprising a process name 1010 and a process cost per link 1020. The process cost per link 1020 is determined for a manual operations mode 1030, a mechanized operation mode 1040, and a manual and mechanized operations mode 1050 for each NIM process. All costs are determined using one currency over a pre-determined time period, for example, in dollars per year.

Under the process name 1010, the NIM processes are listed, wherein the NM processes comprise a customer, services, and resources association management process 1011; an equipment management process 1012; and a network management process 1013.

The customer, services, and resources association management process 1011 comprises tasks for associating customer information with service; and maintaining view of customer, service, and resources relationships. The equipment management process 1012 comprises tasks for defining containment and association rules for adding new equipment; defining hierarchies (e.g., bays, shelf, card, equipment, power supplies, etc.); and showing multiple views of equipment including hierarchical tree view.

The network management process 1013 comprises tasks for creating and deleting network domain; generating libraries of pre-configured equipment; updating of inventory upon successful provisioning; performing real time data synchronization to prevent mismatch work order data; applying work order data changes to all equipment across the network; auditing database routinely; performing syntax and semantic checks on data; real-time database querying for services, network, and customer data; and real time viewing of data for each network element in the network.

The total NIM processes cost is computed by multiplying the owned links count 711 in Table 700 of FIG. 7 for each network architecture by the process cost per link 1020 for the manual and mechanized operations mode 1050 for the NIM processes 1011 to 1013. For fully mechanized operations, the process cost per link 1020 for the manual operations mode 1030 and the manual and mechanized operations mode 1050 would be zero for the NIM processes 1011 to 1013. And for only manual operations, the process cost per link 1020 for the mechanized operations mode 1040 and the manual and mechanized operations mode 1050 would be zero for the NIM processes 1011 to 1013.

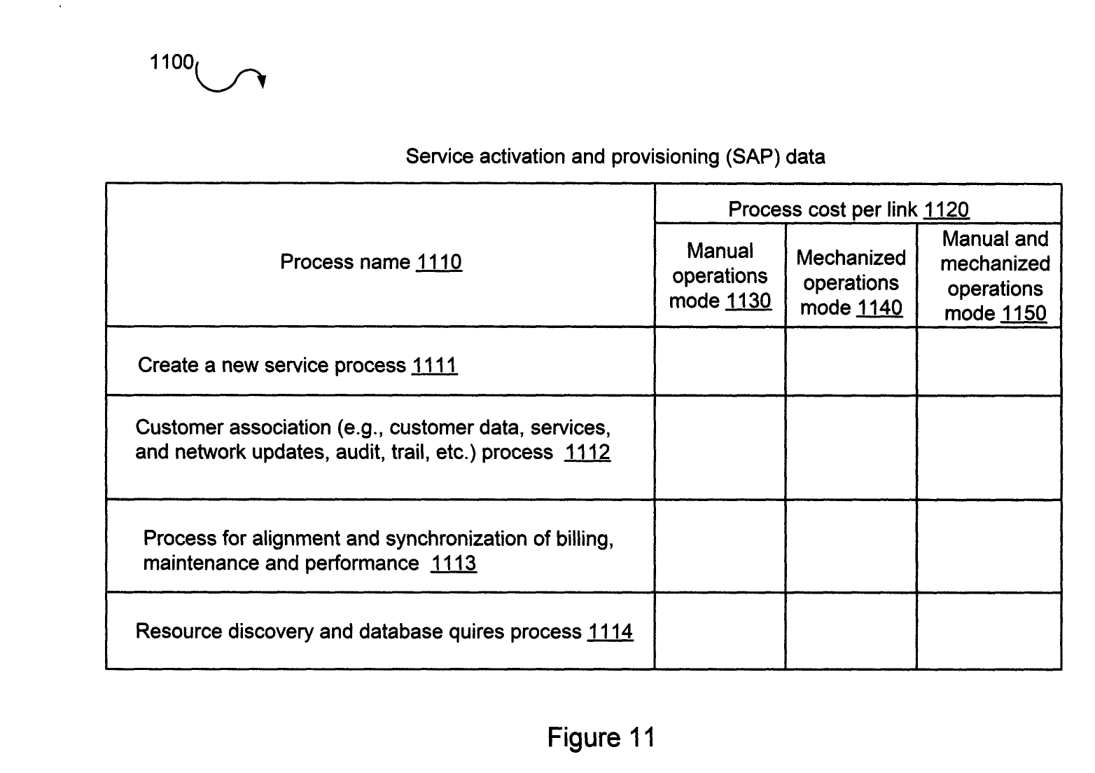

FIG. 11 shows a table 1100 illustrating service activation and provisioning (SAP) data comprising a process name 1110 and a process cost per link 1120. The process cost per link 1120 is determined for a manual operations mode 1130, a mechanized operation mode 1140, and a manual and mechanized operations mode 1150 for each SAP process. All costs are determined using one currency over a predetermined time period, for example, in dollars per year.

Under the process name 1110, the SAP processes are listed, wherein the SAP processes comprise a create a new service process 1111; a customer association process 1112; a process for aligning and synchronizing with billing, maintenance, and performance 1113; and a resource discovery and database quires process 1114.

The create a new service process 1111 comprises tasks for entering new service's setting selected from available network resources; entering request for a new service; opening up a work order to create the service on a set date and time; opening up pending orders in network database to reserve required resources; setting up trigger activation on correct date and time; setting up trigger for a process to apply changes; activating service at edge node; and activating service at customer router node.

The customer association process 1112 comprises tasks for updating database and network with service, network, and customer data; auditing work order trail for history report; and auditing work order trail to access who did what and when it was done. The process for aligning and synchronizing with billing, maintenance, and performance 1113 comprises tasks for updating billing for customer usage service; updating maintenance for trouble reports resolution; and updating performance for collecting performance monitors from network element for QoS and SLA.

The resource discovery and database quires process 1114 comprises tasks for starting service activation; entering card IP address; sending service request to synch card IP address with network; initiating request to start network synchronization; performing queries to get data provisioned in one card; reformatting data into service view and storing in network database; viewing services provisioned in the network; and querying data stored in network database.

The total SAP processes cost is computed by multiplying the owned links count 711 in Table 700 of FIG. 7 for each network architecture by the process cost per link 1120 for the manual and mechanized operations mode 1150 for the SAP processes 1111 to 1114. For the SAP processes 1111 to 1114, the process cost per link 1120 for the manual operations mode 1130 and the manual and mechanized operations mode 1150 would be zero for fully mechanized operations and the process cost per link 1120 for the mechanized operations mode 1140 and the manual and mechanized operations mode 1150 would be zero for only manual operations.

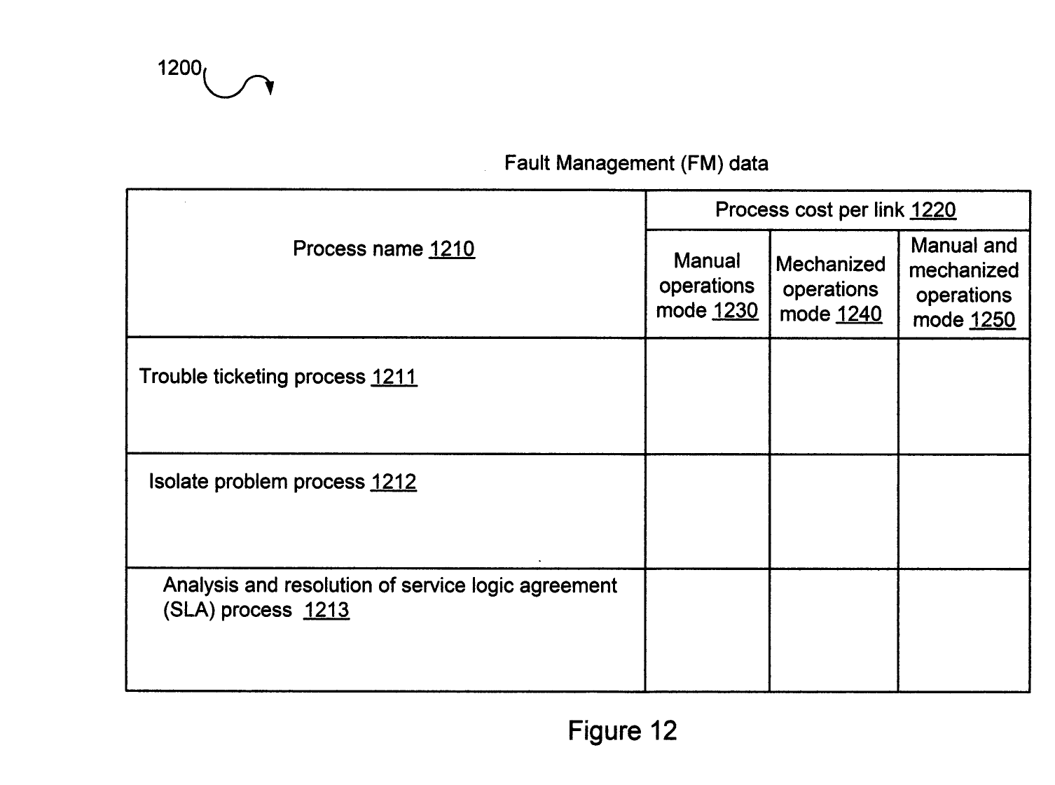

FIG. 12 shows a table 1200 illustrating fault management (FM) data comprising a process name 1210 and a process cost per link 1220. The process cost per link 1220 is determined for a manual operations mode 1230, a mechanized operation mode 1240, and a manual and mechanized operations mode 1250 for each FM process. All costs are determined using one currency over a pre-determined time period, for example, in dollars per year.

Under the process name 1210, the FM processes are listed, wherein the FM processes comprise a trouble ticketing process 1211; an isolate problem process 1212; and an analysis and resolution for service logic agreement (SLA) process 1213.

The trouble ticketing process 1211 comprises tasks for listing all network elements within span of control; checking health of individual network element for efficient troubleshooting; performing trouble ticketing for SLA; detailing all currently active alarms; searching, sorting, and filtering individual alarm information; reaching through network element and element manager; collecting historical details of alarms and events; filtering and tracking active alarms; managing consolidated network alarms; viewing order of priority of alarm severity; correlating alarms; and transmitting trouble ticket identifier into alarm manager.

The isolate problem process 1212 comprises tasks for getting real time performance and status of the network; displaying traffic and protection controls; browsing historical faults; providing list of solutions to a problem; creating ticketing and log cases; setting priority and rate cases; reviewing cases history; and managing configuration and tracking case related costs. The analysis and resolution of SLA process 1213 comprises tasks for generating a service level template for service packages; adding standard definition of availability and QoS; defining threshold for an SLA violation alarm; provisioning performance threshold; mapping a pre-defined template to a particular service; customizing template for a customer or a service; processing order metrics, reporting monthly; and reporting on per port statistics.

The total FM processes cost is computed by multiplying the owned links count 711 in Table 700 of FIG. 7 for each network architecture by the process cost per link 1220 for the manual and mechanized operations mode 1250 for the FM processes 1211 to 1213. For the FM processes 1211 to 1213, the process cost per link 1220 for the manual operations mode 1230 and the manual and mechanized operations mode 1250 would be zero for fully mechanized operations and the process cost per link 1220 for the mechanized operations mode 1240 and the manual and mechanized operations mode 1250 would be zero for only manual operations.

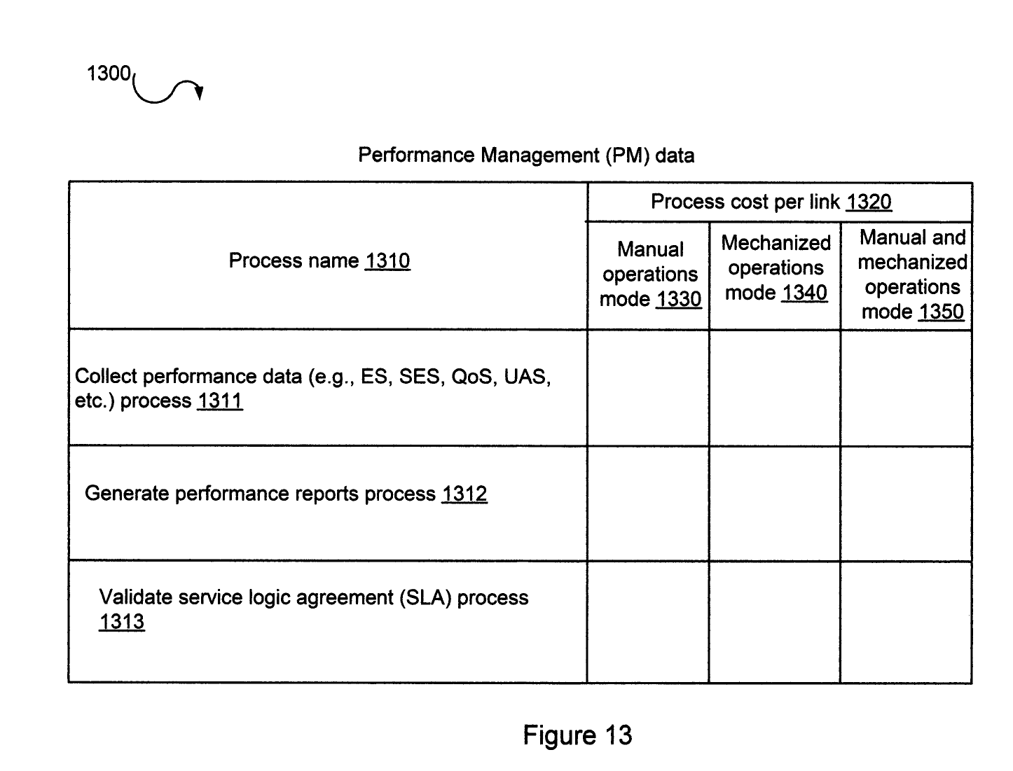

FIG. 13 shows a table 1300 illustrating performance management (PM) data comprising a process name 1310 and a process cost per link 1320. The process cost per link 1320 is determined for a manual operations mode 1330, a mechanized operation mode 1340, and a manual and mechanized operations mode 1350 for each PM process. All costs are determined using one currency over a predetermined time period, for example, in dollars per year.

Under the process name 1310, the PM processes are listed, wherein the PM processes comprise a collect performance data process 1311; a generate performance reports process 1312; and a validate service logic agreement (SLA) process 1313.

The collect performance data process 1311 comprises tasks for collecting performance data from devices; collecting ES and SES to drive QoS metric; collecting UAS to track service availability; collecting and storing performance monitors to database to facilitate after the fact analysis; collecting performance measures from terminating network elements (NEs); collecting performance data for SLA; and collecting operations measurements for links and NEs.

The generate performance reports process 1312 comprises tasks for generating reports on a daily, weekly, monthly, and quarterly bases; distributing reports for network analysis, summary, and utilization, and reports for network element (NE) detail; generating customized reports; generating standard predefined reports; providing historical NE reports; reporting on performance of resources in the network (e.g., trail, circuit, etc.); reporting on service availability; reporting on the availability of each customer service; and reporting on service level performance.

The validate service logic agreement (SLA) process 1313 comprises tasks for determining traffic patterns and trends; browsing performance monitors data; searching, sorting, and copying to file; monitoring transmit and receive power levels; correlating performance monitor data; validating SLA metrics report; viewing network and service performance; assessing QoS and availability metrics; monitoring network and NEs performance; and setting threshold provisioning and threshold crossing alerts.

The total PM processes cost is computed by multiplying the owned links count 711 in Table 700 of FIG. 7 for each network architecture by the process cost per link 1320 for the manual and mechanized operations mode 1350 for the PM processes 1311 to 1313. For the PM processes 1311 to 1313, the process cost perlink 1320 for the manual operations mode 1330 and the manual and mechanized operations mode 1350 would be zero for fully mechanized operations, and the process cost per link 1320 for the mechanized operations mode 1340 and the manual and mechanized operations mode 1350 would be zero for only manual operations.

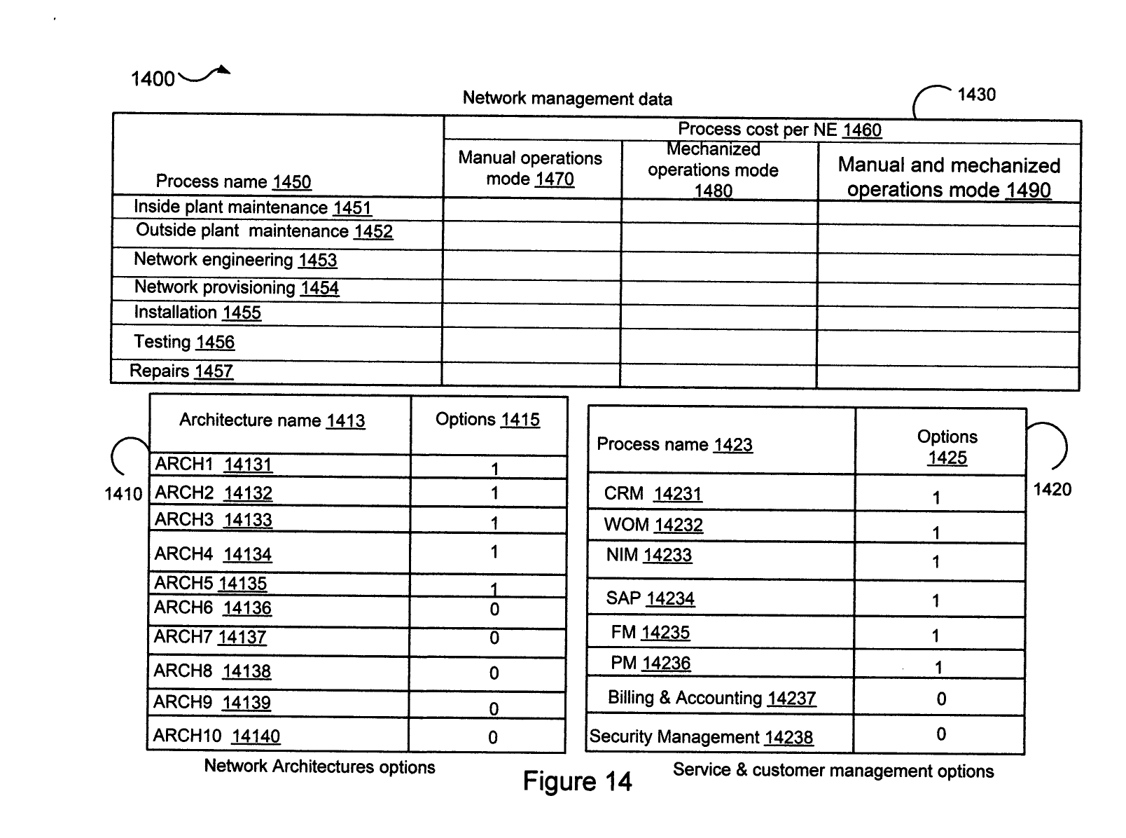

FIG. 14 shows a table 1410 illustrating network architectures options; a table 1420 illustrating service and customer management options; and a table 1430 illustrating network management data.

Table 1410, the network architectures options, comprises an architecture name 1413 and options 1415. Under the architecture name 1413, ARCH1 to ARCH10 14131 to 14140 are listed, wherein each of the ARCH1 to ARCH10 14131 to 14140 represents a single or a hybrid technology, and wherein the technology alternatives comprise ATM, MPLS, FR, optical Ethernet, etc. The options 1415 are binary values 1 for selecting the architecture (e.g., ARCH1 14131 and ARCH2 14132) and 0 for not selecting the architecture (e.g., ARCH6 14136 and ARCH7 14137), as shown in table 1410 of FIG. 14.

Table 1420, the service and customer management options, comprises a process name 1423 and options 1425. Under the process name 1423, the service and customer management processes are listed. These processes comprise CRM 14231, WOM 14232, NIM 14233, SAP 14234, FM 14235, PM 14236, billing and accounting 14237, and security management 14238. The options 1425 are binary values, 1 for 20 selecting the management process (e.g., CRM 14231 and WOM 14232), and 0 for not selecting the management process (e.g., billing & accounting 14237 and security management 14238), as shown in table 1420 of FIG. 14.

Table 1430, the network management data, comprises a process name 1450 and a process cost per node 1460. The process cost per node 1460 is determined for a manual operations mode 1470, a mechanized operation mode 1480, and a manual and mechanized operations mode 1490 for each network management process. All costs are determined using one currency over a predetermined time period, for example, in dollars per year.

Under the process name 1450, the network management processes are listed, wherein the network management processes comprise inside plant maintenance 1451; outside plant maintenance 1452; network engineering 1453; network provisioning 1454; installation 1455; testing 1456; and repairs 1457.

The total network management processes cost is computed by multiplying the sum of the owned NEs count 550 in table 500 of FIG. 5 and the owned CPE count 650 in table 600 of FIG. 6 for each network architecture by the process cost per NE 1460 for the manual and mechanized operations mode 1490 for the network management processes 1451 to 1457. For the network management processes 1451 to 1457, the process cost per NE 1460 for the manual operations mode 1470 and the manual and mechanized operations mode 1490 would be zero for fully mechanized operations, and the process cost per NE 1460 for the mechanized operations mode 1480 and the manual and mechanized operations mode 1490 would be zero for only manual operations.

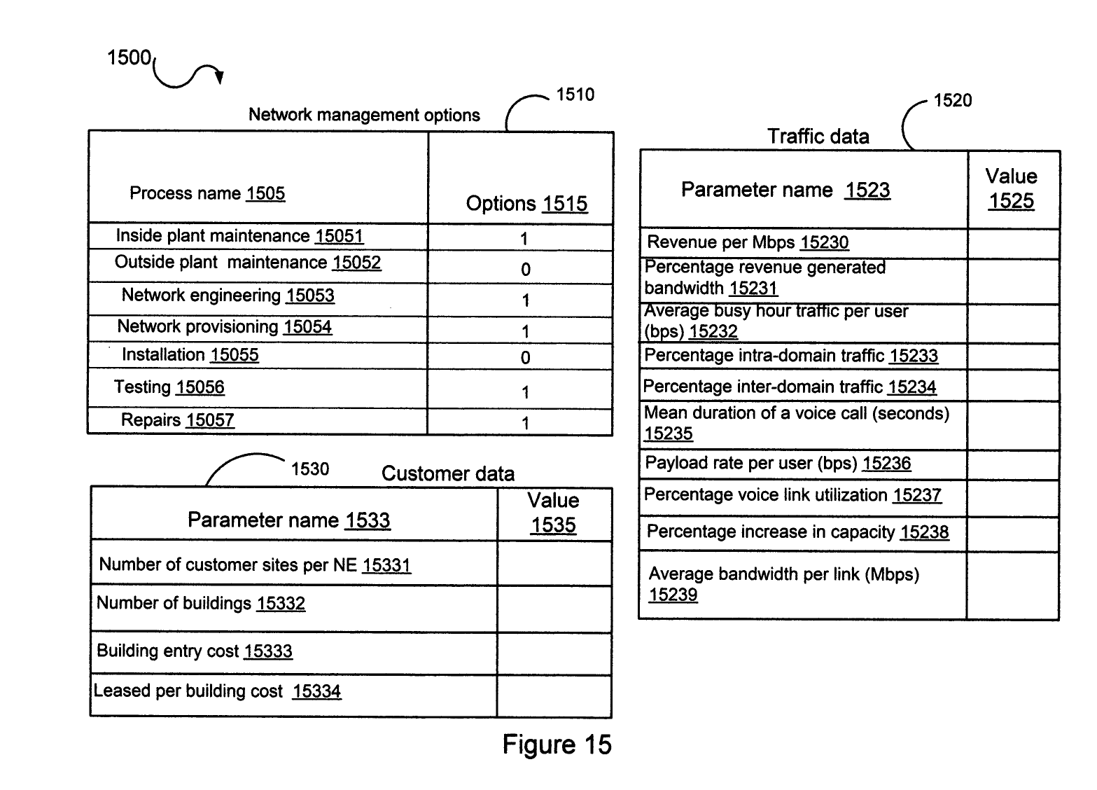

FIG. 15 shows a table 1510 illustrating network management options; a table 1520 illustrating traffic data; and a table 1530 illustrating customer data 1530.

Table 1510, the network management options, comprises a process name 1505 and options 1515. Under the process name 1505, the network management processes are listed, wherein the network management processes comprise inside plant maintenance 15051; outside plant maintenance 15052; network engineering 15053; network provisioning 15054; installation 15055; testing 15056; and repairs 15057. The options 1515 are binary values, 1 for selecting the network management process (e.g., network engineering 15053 and testing 15056) and 0 for not selecting the network management process (e.g., installation 15055 and outside plant 15052), as shown in table 1510 of FIG. 15.

Table 1520, the traffic data, comprises a parameter name 1523 and a value 1525. Under the parameter name 1523, traffic parameters are listed, wherein the traffic parameters comprise a revenue per Mbps 15230; a percentage revenue generated bandwidth 15231; an average busy hour traffic per user (in bps) 15232; a percentage intra-domain traffic 15233; a percentage inter-domain traffic 15234; a mean duration of voice call (in seconds) 15235; a payload rate per user (in bps) 15236; a percentage voice link utilization 15237; a percentage increase in capacity 15238; and an average bandwidth per link (in Mbps) 15239. These parameters reflect different quality of services such as standard (for e-mail, file transfer, and non-critical Internet access), priority (for critical Internet access, point-of-sale, and streaming video), and near real-time (for voice over 1P and video conferencing) classes of services. Under the value 1525, the values for said parameters are determined.

Table 1530, the customer data, comprises parameter name 1533 and a value 1535. Under the parameter name 1533, customer related parameters are listed, wherein the parameters comprise a number of customer sites per edge node (or NE) 15331; a number of buildings 15332; a building entry cost 15333; and a leased per building cost 15334. Under the value 1535, the values for said parameters are determined.

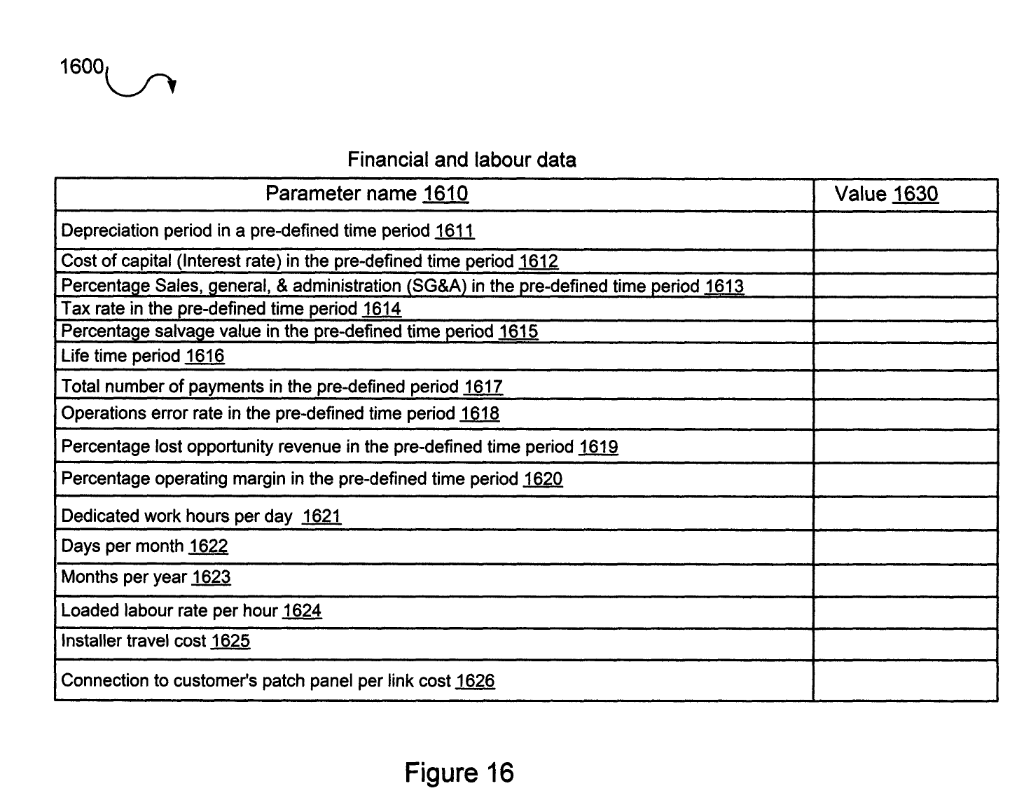

FIG. 16 shows a table 1600 illustrating financial and labour data comprising a parameter name 1610 and value 1630. Under the parameter name 1610, the financial parameters are listed, wherein the financial parameters comprise a depreciation period 1611; a cost of capital (interest rate) 1612; a percentage sales, general, and administration (SG&A) 1613; a tax rate 1614; a percentage salvage value 1615; a life time period 1616; a total number of payment periods 1617; an operations error rate 1618; a percentage lost opportunity revenue 1619; and a percentage operating margin 1620. Table 1600 further comprises labour data such as a number of dedicated work hours per day 1621; a number of days per month 1622; a number of months per year 1623; a loaded labour rate 1624; an installer travel cost 1625; and a connection to customers' patch panel per link cost 1626. Under the value 1630, the values for said parameters are determined.

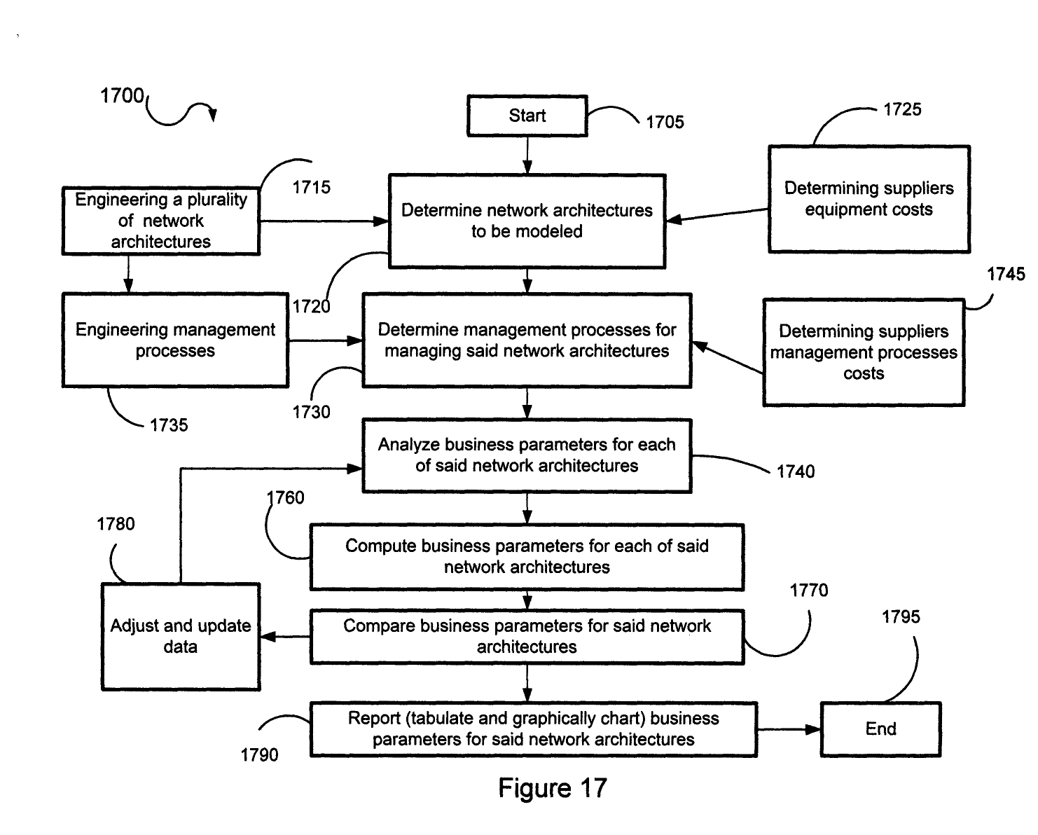

FIG. 17 shows a flow chart diagram 1700 illustrating a method for developing business solution for a telecommunications network using the OMCS tool of FIG. 1, wherein upon start up (block 1705), procedure 1700 determines the network architectures to be modeled (block 1720) by selecting the options 1415 in table 1410 of FIG. 14 that point to engineering a plurality of network architectures (block 1715), wherein said network architectures having one or more of the following technology: TDM, ATM, FR, IP, VPN, MPLS, and optical Ethernet including fiber, SONET, RPR, and DWDM.

Using network planning and engineering principles, each of the network architectures (block 1715) is configured to meet the traffic data in table 1520 and customer data in table 1530 of FIG. 15. Procedure 1700 determines equipment and leasing costs for each of the network architectures (block 1725).

Procedure 1700 determines the management processes (block 1730) for managing each of said network architectures by selecting the options 1515 for network management options in table 1510 of FIG. 15, and the options 1425 for service and customer management options in table 1420 of FIG. 14, that point to the management processes (Block 1735). Procedure 1700 determines management processes cost for managing each of the network architectures (block 1745).

Procedure 1700 analyzes the received data (block 1740) to compute business parameters for each of the network architectures. Procedure 1700 computes (block 1760) the business parameters over a pre-determined study period, (e.g., 5 years). The business parameters comprise CAPEX, OPEX, total expenditure, revenue, capacity, ROI, EBITDA, EBIT, OPEX as percentage of revenue, and total expenditure as percentage of revenue.

Procedure 1700 compares the computed business parameters (block 1770) for said network architectures for determining cost savings of one network architecture versus another and for determining the network architecture with the least total expenditure.

Procedure 1700 employs the percentage increase in capacity 15238 in table 1520 of FIG. 15 to estimate growth in network architectures and management processes data over a pre-determined study period, (for example, five years). As before, the pre-determined study period comprises a plurality of predetermined time periods, (for example, the pre-determined time period could be a month or a year and the predetermined study period could be five or ten years).

Procedure 1700 updates the network architectures and management processes data 230 of FIG. 2 for each of the pre-determined time periods, and the business parameters are determined accordingly, for each of the network architectures over the pre-determined study period, (that is, for each year in a five years study period, for example).

Procedure 1700 adjusts and updates data (block 1780) as required and re-analyzes the business parameters (block 1740). When analysis is completed for the pre-determined study period, procedure 1700 reports the business parameters for said network architectures over the pre-determined study period. The reporting of said business parameters comprises tabulating and graphically charting the business parameters for each of the network architectures over said pre-determined study period, thus, finishing the procedure 1700 (block 1795).

In computing the business parameters for each of the network architectures, generally accepted accounting principles are applied to the network architectures costs in tables 500, 600, and 700 of FIGS. 5, 6, and 7, respectively, and the management processes costs described in FIGS. 8 to 14 above.

The leasing cost for each of the network architectures is determined from the total power consumptions 590 for NEs and the total power consumptions 690 for CPE in tables 500 and 600 of FIGS. 5 and 6, respectively. The leased links and ports cost is determined from the total leased links cost 760, the total leased links for unit length cost 765, and the total leased ports cost 750 in table 700 of FIG. 7.

The depreciation and amortization (D/A), taxes, interests, and the SG&A (sales, general and administration) are computed to meet the financial parameters 1611 to 1620 in table 1600 of FIG. 6. Then, the CAPEX and the OPEX are computed for each of the network architectures as follows:
CAPEX=a network architecture cost+Taxes+Interests+D/A, (1)
OPEX=a management processes cost+a leasing cost+SG&A (2)

From Formulae (1) and (2), the total expenditure is computed as follows:
Total expenditure=CAPEX+OPEX (3)

The total access capacity (Mbps) 780 is determined for each of the network architectures from table 700 of FIG. 7. Then, revenue for each of the network architectures is computed by multiplying the total access capacity (Mbps) 780 in table 700 of FIG. 7 by the revenue per Mbps 15230 and by the percentage revenue generating bandwidth 15231 in table 1520 of FIG. 15.

Thus, financial statistics such as EBITDA, EBIT, OPEX as percentage of revenue, total expenditure as percentage of revenue, and ROI are computed using the following well known formulae for each of said network architectures:
EBIRDA=Revenue−OPEX;
EBIT=Revenue−(OPEX+D/A);
OPEX as (%) of revenue=100*(OPEX/Revenue);
Total expenditure as (%) of revenue=100*(total expenditure/Revenue); and
ROI=Total expenditure/the total access capacity.

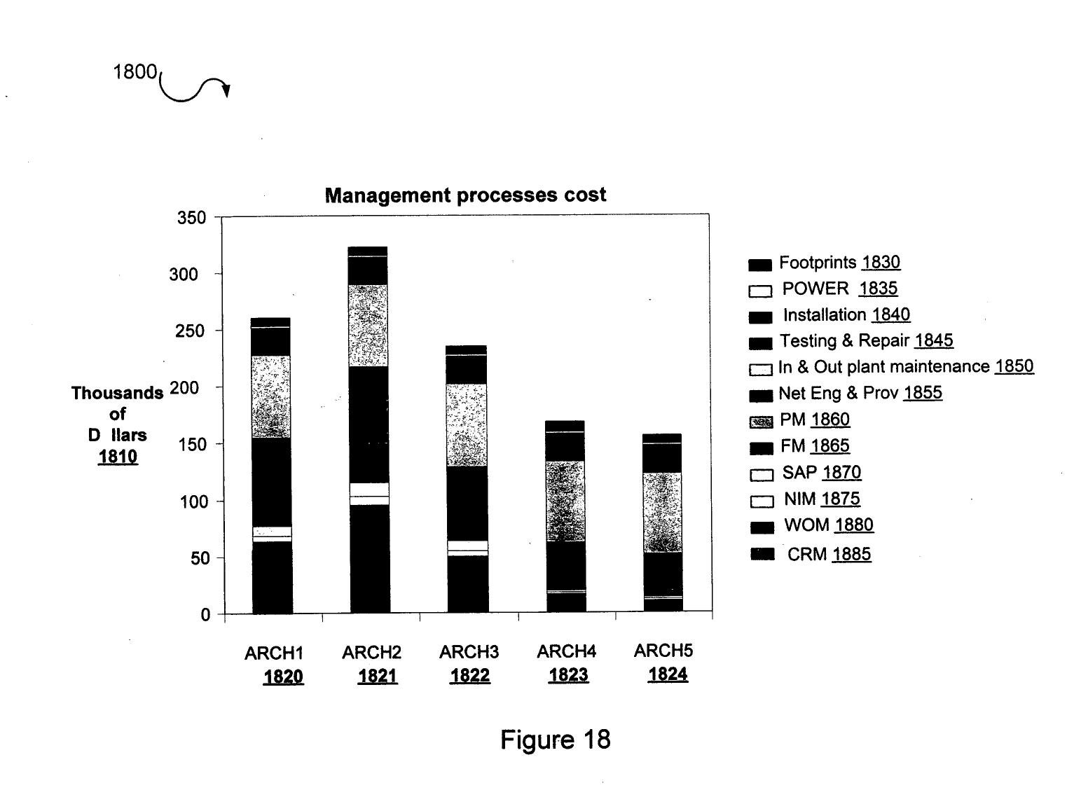

FIG. 18 shows an illustrative graphical output from an execution of the OMCS tool of FIG. 1. The graph 1800 plots thousands of dollars 1810 and five network architectures ARCH1 1820, ARCH2 1821, ARCH3 1822, ARCH4 1823, and ARCH5 1824. The five network architectures represent five different virtual private networks (VPNs) technologies, wherein ARCH1 1820 is a layer 2 ATM; ARCH2 1821 is a layer 3 MPLS with QoS; ARCH3 1822 is a layer 2 ATM with private network to network interface (PNNI); ARCH4 1823 is a layer 2 MPLS; and ARCH5 is a layer 2 optical Ethernet over RPR.

The ARCH1 1820 is a layer 2 ATM architecture that requires fully meshed overlay networks. In this architecture, routing is implemented by creating permanent virtual connection (PVC) between nodes. This architecture is similar to the fully meshed architecture of the telecommunications network of FIG. 3, and because it is fully meshed, it requires a large number of PVCs, and the PVCs require a considerable management effort and, hence, increase its OPEX.

The ARCH2 1821 is a layer 3 MPLS with QoS architecture that requires full meshed point-to-point connections between service provider edge nodes (or NEs). This architecture is also similar to that of FIG. 3. This architecture implements routing functionality throughout the service provider network, pushing all the way to customer premise. In this architecture, complex routing operations are distributed over service provider core network increasing its OPEX and accordingly, increasing its total expenditures over ARCH1 1820.

The ARCH3 1822 is a layer 2 ATM architecture that uses private network to network interface (PNNI) routing system to route the call, handle signaling, set up connection, and re-establish connection after network failure. The PNNI improves the performance of the ATM network, since routing decisions are not required at each node between the ingress and egress nodes. Accordingly, the ATM with PNNI reduces OPEX by performing some management processes at edge nodes only.

The ARCH4 1823 is a Layer 2 MPLS architecture wherein packets are switched based on generic labels. The ARCH4 1823 is an enhancement over ARCH1 1820 and ARCH2 1821 and it provides the capability to set-up tunnels through the routed network. In this architecture, the packets flow from ingress to egress nodes and the edge node participates in layer 3 administrative duties. Here, the OPEX is reduced due to simplicity in the architecture technology using rings as shown in the architecture of the telecommunications network of FIG. 4.

The ARCH5 1824 is a layer 2 optical Ethernet architecture that off-loads many of the layer 3 administrative duties and eliminates traffic bottleneck between local and wide area networks. This technology uses ring architecture similar to that of the telecommunications network of FIG. 4. When a port on the edge node connected to customer's site is provisioned the edge node registers the customer's site information and the routers broadcast the routing information onto inter-office rings and all rings, and then, core nodes are activated for Ethernet path for the customer, and the Ethernet path between customer sites are established. Here, the OPEX is further reduced due to simplicity in the technology.

In graph 1800 it can be seen that the management processes cost for ARCH2 1821 technology is higher than other architectures technologies ARCH1 1820, ARCH3 1822, ARCH4 1823, and ARCH5 1824. From the graph 1800 it can also be seen that ARCH5 1824 has the least management processes cost.

In graph 1800, for each network architecture, the management processes costs are shown comprising footprints 1830, power consumptions 1835, installation 1840, testing and repairs 1845, inside and outside plant maintenance 1850, network engineering and provisioning 1855, performance management (PM) 1860, fault management (FM) 1865, service activation and provisioning (SAP) 1870, network inventory management (NIM) 1875, work order management (WOM) 1880, and customer relationship management (CRM) 1885.

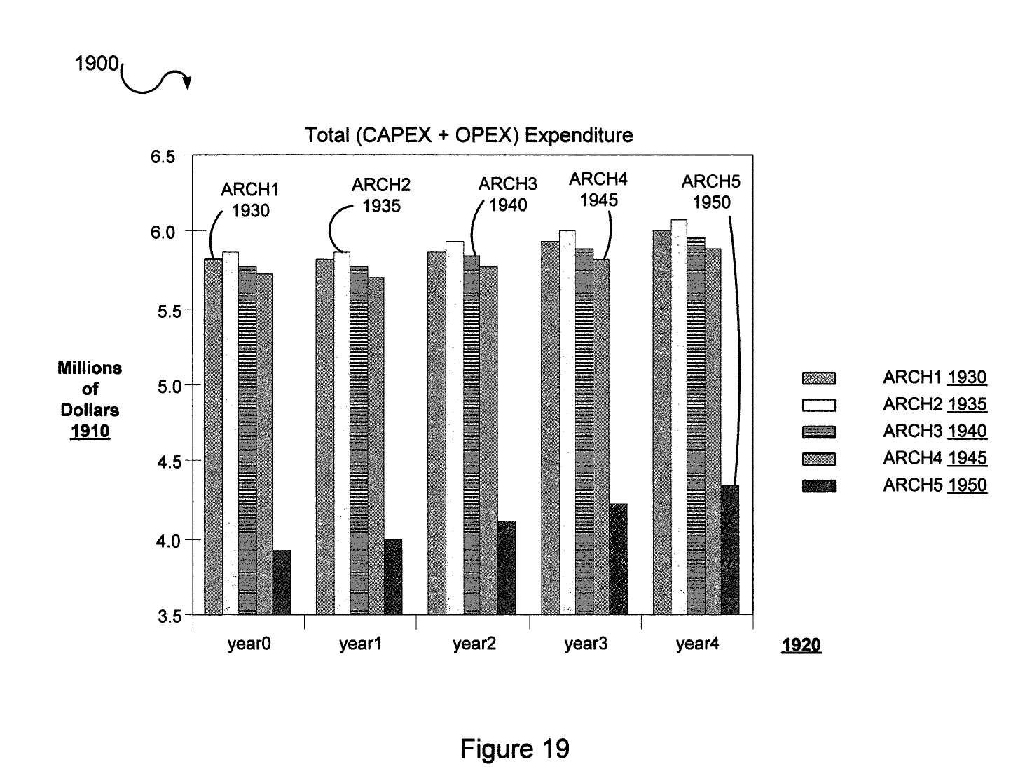

FIG. 19 shows an illustrative graphical output from an execution of the OMCS tool of FIG. 1. The graph 1900 plots millions of dollars 1910 over a five years study period 1920, year0, year1, year2, year3, and year4 for five network architectures ARCH1 1930, ARCH2 1935, ARCH3 1940, ARCH4 1945, and ARCH5 1950. The five network architectures represent the five different technologies described in FIG. 18 above. In graph 1900 it can be seen that the total expenditure (CAPEX and OPEX) for ARCH5 1950 is lower than the other architectures ARCH1 1930, ARCH2 1935, ARCH3 1940, and ARCH4 1945. From the graph 1900 it can also be seen that ARCH2 1935 has the highest total expenditure.

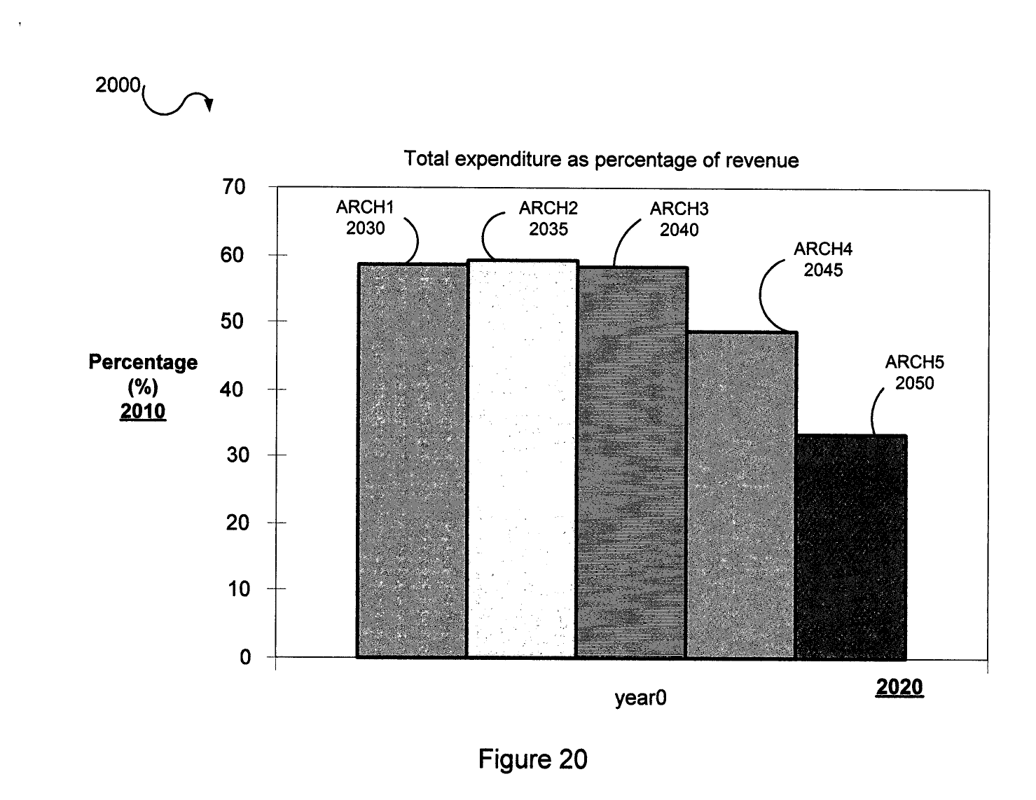

FIG. 20 shows an illustrative graphical output from an execution of the OMCS tool of FIG. 1. The graph 2000 plots percentage 2010 over one year 2020, year0, for five network architectures ARCH1 2030, ARCH2 2035, ARCH3 2040, ARCH4 2045, and ARCH5 2050. The five network architectures represent the five different technologies described in FIG. 18 above. In graph 2000 it can be seen that the total expenditure as percentage of revenue for ARCH5 2050 is lower than the other architectures.

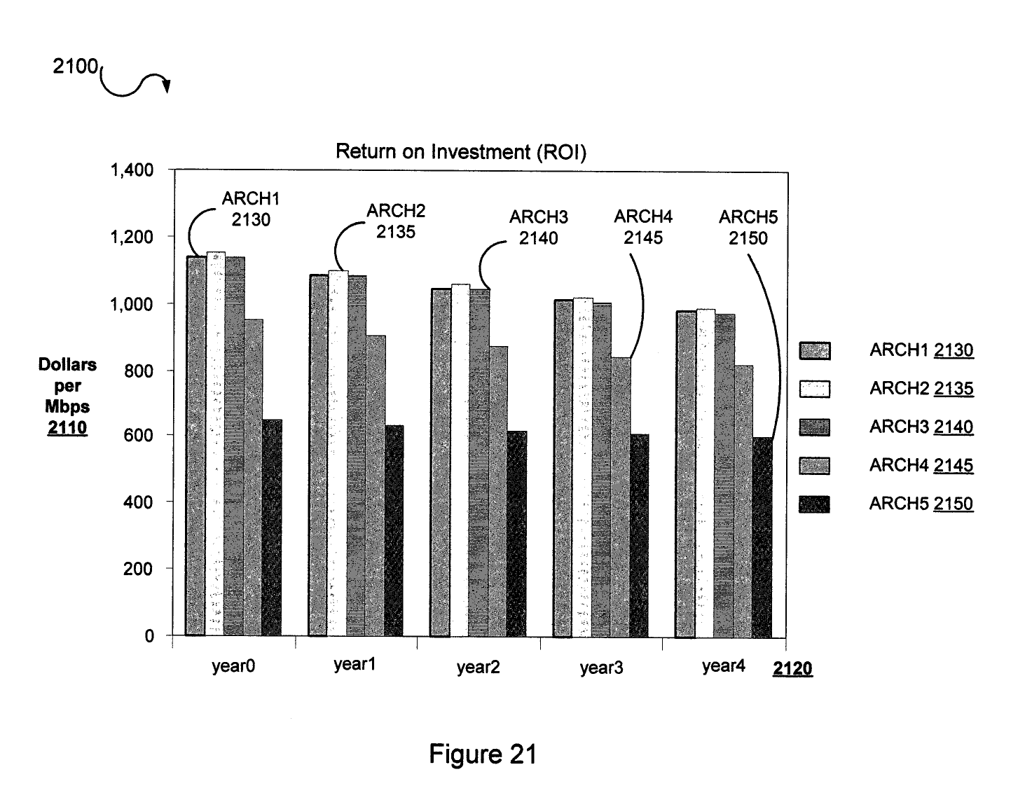

FIG. 21 shows an illustrative graphical output from an execution of the OMCS tool of FIG. 1. The graph 2100 plots dollars per Mbps 2010 over five years study period 2120, year0, year1, year2, year3, and year4 for five network architectures ARCH1 2130, ARCH2 2135, ARCH3 2140, ARCH4 2145, and ARCH5 2150. The five architectures represent the five different technologies described in FIG. 18 above. In graph 2100 it can be seen that the return on investment for ARCH5 2050 is higher than the other architectures.

The embodiments of this invention provide a software tool that automates the calculation of the business parameters for a plurality of network architectures. The OMCS tool enables comparison of different network architectures comprising NEs, CPE, and links from the same or different equipment suppliers, and network, service, and customer management processes from the same or different management processes suppliers.

Appreciably, the OMCS tool estimates the business parameters for a business solution that articulates the network architecture with the least total expenditure and provides a comprehensive view of the CAPEX and the OPEX. The tool enables service providers to develop a comprehensive business solution that enables them to plan different technology for their evolving network architectures, quantify the business parameters for each of the network architectures, and identify the areas for cost reduction.

Advantageously, the present invention may be utilized to modify an existing network architecture (such as an existing ATM or frame relay architecture) to move closely and coincide with another articulated business solution or to develop a new business solution (such as an MPLS or optical Ethernet architecture).

The present invention provides a software tool and method for business solution for a telecommunications network. It will be apparent to those with skill in the art that modifications to the above methods and embodiments can occur without deviating from the scope of the present invention. Accordingly, the disclosures and descriptions herein are intended to be illustrative, but not limiting, of the scope of the invention which is set forth in the following claims.

1. An operations, management, capacity, and services (OMCS) tool comprising:
a means for analyzing business parameters for a plurality of network architectures; and
a means for comparing the business parameters for said network architectures for determining cost savings of one network architecture versus another and for determining a business solution that articulates the network architecture for reducing total expenditure.

2. A tool as described in claim 1, wherein the business parameters comprise the total expenditure; and wherein the total expenditure comprises capital expenditure (CAPEX) and operational expenditure (OPEX).

3. A tool as described in claim 2, wherein the CAPEX comprises a network architecture cost, taxes, interests, and deprecation and amortization (D/A) expenses; and the OPEX comprises a management processes cost, a leasing cost, and sales, general and administration (SG&A) expenses.

4. A tool as described in claim 2, wherein the business parameters further comprise revenue; capacity; return on investment (ROI); earnings before interest, taxes, and deprecation and amortization (EBITDA); earnings before interest and taxes (EBIT); OPEX as percentage of revenue; and total expenditure as percentage of revenue.

5. A tool as described in claim 1, wherein the means for analyzing the business parameters comprises a means for analyzing the business parameters for a network architecture having one or more of the following technology: TDM, ATM, FR, IP, VPN, MPLS, and optical Ethernet including fiber, SONET, RPR, and DWDM.

6. A tool as described in claim 5, wherein the means for analyzing the business parameters for the plurality of network architectures comprises a means for computing the business parameters for each of said network architectures over a pre-determined study period.

7. A tool as described in claim 6, wherein the means for comparing the business parameters for the plurality of network architectures comprises a means for reporting the business parameters for each of said network architectures over said pre-determined study period; and wherein the business solution comprises the network architecture with the least total expenditure.

8. A tool as described in claim 3, further comprises:
a means for engineering a plurality of network architectures for a pre-determined input user data;
a means for determining a network architecture cost and a leasing cost for each of said network architectures over a predetermined study period;
a means for engineering management processes for managing each of said network architectures; and
a means for determining a management processes cost for said management processes over said predetermined study period.

9. A tool as described in claim 8, further comprises:
a means for inputting user data; and
a means for validating and calibrating the input user data; the network architecture cost; the leasing cost; and the management processes cost for each of said network architectures.

10. A tool as described in claim 8, wherein the means for engineering the plurality of network architectures comprises a means for determining an owned network elements (NEs) count; a leased NEs count; an owned customer premise equipment (CPE) count; a leased CPE count; an owned links count; a leased links count; and a leased ports count for each of said network architectures; and wherein said network architectures having NEs, CPE, and links from the same or different equipment suppliers.

11. A tool as described in claim 10, wherein the means for determining the network architecture cost and the leasing cost for each of the plurality of network architectures comprises:
a means for determining a price per network element (NE), a footprint per NE cost, and a power consumption per NE cost;
a means for determining a price per CPE, a footprint per CPE cost, and a power consumption per CPE cost; and
a means for determining a price per link and a link transmission rate.

12. A tool as described in claim I1, wherein the means for determining the network architecture cost comprises a means for computing a total owned NEs cost; a total owned CPE cost; and a total owned links cost for each of said network architectures over said pre-determined study period; and wherein the means for determining the leasing cost comprises a means for computing a total footprints cost and a total power consumptions cost for said owned NEs and CPE over said pre-determined study period.

13. A tool as described in claim 10, wherein the means for determining the leasing cost further comprises:
a means for determining a leased per NE cost, a footprint per NE cost, and a power consumption per NE cost;
a means for determining a leased per CPE cost, a footprint per CPE cost, and a power consumption per CPE cost;
a means for determining a leased per link cost and a link transmission rate;
a means for determining a leased link per unit length cost, a unit length per link count, and a link transmission rate; and
a means for determining a leased per port cost.

14. A tool as described in claim 13, wherein the means for determining the leasing cost comprises a means for computing a total leased NEs cost; a total leased CPE cost; a total footprints cost and a total power consumptions cost for said leased NEs and CPE; a total leased links cost; a total leased links for unit length cost; and a total leased ports cost for each of said network architectures over said pre-determined study period.

15. A tool as described in claim 8, wherein the means for engineering the management processes comprises means for engineering network management processes, and service and customer management processes; and wherein said management processes having processes from the same or different management processes suppliers.

16. A tool as described in claim 15, wherein the means for engineering network management processes comprises a means for selecting one or more of the following processes: inside plant maintenance; outside plant maintenance; network engineering; network provisioning; installation; testing; and repairs.

17. A tool as described in claim 16, wherein the means for determining the management processes cost comprises a means for determining a process cost per NE for each of said network management processes for one or more of the following: a manual operations mode; a mechanized operations mode; and a manual and mechanized operations mode.

18. A tool as described in claim 15, wherein the means for engineering service and customer management processes comprises a means for selecting one or more of the following processes: customer relationship management (CRM); work order management (WOM); network inventory management (NDI); service activation and provisioning (SAP); fault management (FM); performance management (PM); accounting and billing; and security management.

19. A tool as described in claim 18, wherein the means for determining the management processes cost comprises a means for determining a process cost per link for each of said service and customer management processes for one or more of the following: a manual operations mode; a mechanized operations mode; and a manual and mechanized operations mode.

20. A computer program containing instructions for directing a computer to perform a process for analyzing business parameters for a plurality of network architectures, and comparing the business parameters for said network architectures over a pre-determined study period, the program comprising:
a means for causing the computer to receive data for the plurality of network architectures;
a means for causing the computer to analyze the received data to compute the business parameters for said network architectures; and
a means for causing the computer to compare said computed business parameters for said network architectures for determining cost savings of one network architecture versus another and for determining a business solution that articulates the network architecture for reducing total expenditure.

21. A program as described in claim 20, wherein the means for causing the computer to receive the data for the plurality of network architectures comprises:
a means for causing the computer to receive input user data for said network architectures;
a means for causing the computer to receive network architectures data for said network architectures; and
a means for causing the computer to receive management processes data for managing each of said network architectures.

22. A program as described in claim 21, wherein the means for causing the computer to receive the input user data comprises a means for causing the computer to receive traffic data; customer data; and financial and labour data for the plurality of network architectures.

23. A program as described in claim 21, wherein the means for causing the computer to receive the network architectures data comprises means for causing the computer to receive network elements (NEs) data; CPE data; and links and ports data for the plurality of network architectures.

24. A program as described in claim 23, wherein the means for causing the computer to receive the network architectures data further comprises a means for causing the computer to receive network architectures options for the plurality of network architectures.

25. A program as described in claim 21, wherein the means for causing the computer to receive the management processes data comprises means for causing the computer to receive network management data; and service and customer management data for managing each of the plurality of network architectures.

26. A program as described in claim 25, wherein the means for causing the computer to receive the management processes data further comprises means for causing the computer to receive network management options; and service and customer management options for managing each of said network architectures.

27. A program as described in claim 20, wherein the means for causing the computer to analyze the received data comprises a means for causing the computer to compute the business parameters for said network architectures over said pre-determined study period.

28. A program as described in claim 20, wherein the means for causing the computer to compare said business parameters for said network architectures comprises a means for causing the computer to tabulate and graphically chart the business parameters for said network architectures over said pre-determined study period.

29. A computer program as described in claim 20, wherein the program is a self-contained Microsoft EXCEL-based decision support software tool comprises a plurality of EXCEL workbooks linked together.

30. A computer program as described in claim 20, wherein the program is a self-contained software tool comprises a number of sub-programs linked together and the sub-programs are written in one or more of the following computer languages: machine language, C/C++, virtual basic, and Java.

31. A method for developing business solution for a telecommunications network, the method comprising the steps of:
receiving data for a plurality of network architectures;
analyzing the received data to compute business parameters for said network architectures; and
comparing said computed business parameters for said network architectures for determining cost savings of one network architecture versus another and for determining a business solution that articulates the network architecture for reducing total expenditure.

32. A method as described in claim 31, wherein the business parameters comprise the total expenditure; and wherein the total expenditure comprises CAPEX and OPEX.

33. A method as described in claim 32, wherein the business parameters further comprise revenue, capacity, ROI, EBITDA, EBIT, OPEX as percentage of revenue, and total expenditure as percentage of revenue.

34. A method as described in claim 31, wherein the step of receiving data comprises a step of receiving input user data; network architectures data; management processes data; network architectures options; network management processes options; and service and customer management processes options for the plurality of network architectures.

35. A method as described in claim 31, wherein the step of analyzing the business parameters comprises a step of analyzing the business parameters for a network architecture having one or more of the following technology: TDM, ATM, FR, IP, VPN, MPLS, and optical Ethernet including fiber, SONET, RPR, and DWDM.

36. A method as described in claim 35, wherein the step of analyzing the business parameters comprises a step of adjusting and updating data for said network architectures.

37. A method as described in claim 31, wherein the step of comparing the business parameters for the plurality of network architectures comprises a step of reporting said business parameters for said network architectures over a pre-determined study period; and wherein the business solution comprises the network architecture with the least total expenditure, and said network architecture having NEs, CPE, and links from the same or different equipment suppliers; and having network management processes, and service and customer management processes from the same or different management processes suppliers.

38. A method as described in claim 37, wherein the step of reporting the business parameters comprises a step of tabulating and graphically charting the business parameters for each of said network architectures over said pre-determined study period.
